(19) United States
(12) Patent Application Publication
(10) Pub. No.: US 2006/0269472 A1
(43) Pub. Date: Nov. 30, 2006

(54) Aluminosilicated of zeolite n structure

(75) Inventors: Ian Mackinnon, Brisbane (AU); Graeme Millar, Brisbane (AU); Wanda Stolz, Brisbane (AU)

Correspondence Address: George M Kaplan;DILWORTH & BARRESE, Suite 702, 333 Earle Ovington Boulevard, Uniondale, NY, 11553, US

(73) Assignee: NANOCHEM HOLDINGS PTY LTD, St Lucia (AU)

(21) Appl. No.: 10/552,021

(22) PCT Filed: Apr. 2, 2004
(86) PCT No.: PCT/AU04/00428

§ 371 Date: Jul. 26, 2006

(30) Foreign Application Priority Data
Apr. 4, 2003 (AU) 2003901594

(51) Int. Cl. C01B 39/00

(52) U.S. Cl. 423/700; 423/709

(57) ABSTRACT

A process for making aluminosilicates of zeolite N structure comprising the steps of: (i) combining a water soluble monovalent cation, a solution of hydroxyl anions and an aluminosilicate to form a resultant mixture having a pH greater than 10 and a H₂O/Al₂O₃ ratio in the range 30 to 220; (ii) heating the resultant mixture to a temperature of between 50° C. and boiling point of the mixture for a time between 1 minute and 100 hours until a crystalline product of zeolite N structure is formed as determined by X-ray diffraction or other suitable characteristic; and (iii) separating the zeolite N product as a solid from the mixture.

### FIELD OF THE INVENTION

This invention describes a process for the production of crystalline aluminosilicate zeolites having the N structure. The products of this process are novel compositions of matter with exceptional selectivity for ion exchange of certain species from solutions. These novel products demonstrate physical and chemical characteristics attributable to the method of production. Zeolite N materials of this invention may be used as components of ion-exchange processes; as adsorbents; as molecular sieves or as catalytic materials. Modification of the surface of zeolite N with surfactants allows the material to adsorb anionic species. Thus, this novel material can be used in numerous industrial, agricultural, environmental, health and medical applications.

### BACKGROUND OF THE INVENTION

Zeolites are three-dimensional, microporous, crystalline solids with well-defined structures that typically contain aluminium, silicon, and oxygen in a regular framework; cations and water are located within the framework pores. A representative formula for a zeolite is:
M_{2/n}O.Al₂O₃.xSiO₂.YH₂O
where M=the exchangeable cation, n represents the cation valence, x is equal to or greater than 2 and Y is the level of hydration. Zeolites are classified in terms of their framework structure type.

Zeolites with Si:Al ratio between 1.0 and 2.0 such as zeolite A, zeolite P, zeolite X and zeolite F have been synthesized at industrial scale. General descriptions of the zeolite groups are detailed in texts by Breck (1974) and Szosak (1998) and prior art referred to in the attached Bibliography is fully incorporated into this specification by way of reference.

The crystal structure of hydro-thermally synthesised zeolite N has been determined by Christensen and Fjellv\dot{a}g (1997) using synchrotron X-ray powder diffraction. This work and a subsequent study (Christensen and Fjellv\dot{a}g, 1999), used laboratory-scale quantities of zeolite 4A, sodium aluminosilicate gel and potassium chloride heated in an autoclave at 300° C. for 7 days to crystallise zeolite N from a static solution. Structural studies show that zeolite N is orthorhombic with space group I222. Cell dimensions for hydro-thermally synthesised zeolite N are a=9.9041(2), b=9.8860(2), c=13.0900(2) with the composition K₁₂Al₁₀Si₁₀O₁₀Cl₂.8H₂O (Christensen and Fjellv\dot{a}g, 1997).

Potassium exchanged aluminosilicates have received little attention in the prior art compared to the commonly available sodium exchanged zeolites. Barrer identified a group of potassic zeolites including zeolite F and a form which is now known as zeolite N. Synthetic zeolite K—F described by Barrer et al., (1953) and Barrer and Baynham (1956) was structurally defined by Baerlocher and Barrer (1974) in the sodium exchanged form. Further work on potassium-derived zeolites by Barrer and Marcilly (1970) defined salt-bearing forms of zeolites within the K—F structure type. These aforementioned syntheses were generally via hydrothermal crystallisation or re-crystallisation of minerals or gels at temperatures greater than 100° C. in an autoclave.

Low yields of zeolite K—F(Cl) by hydrothermal recrystallisation of analcite and leucite with excess KCl is described by Barrer and Marcilly (1970). Barrer and Marcilly (1970) obtained good yields of zeolite K—F(Cl) by hydrothermal synthesis from crystalline Linde Na—X at temperatures between 200° C. and 400° C. Higher yields are obtained at temperatures close to 400° C. Barrer and Marcilly (1970) found that this synthesis procedure using the clay mineral kaolinite yields kaliophyllite at T>200° C. Barrer and Marcilly (1970) used X-ray diffraction data to suggest that these hydro-thermally synthesised zeolites are a tetragonal zeolite K—F structure. However, more recent work by Christensen and Fjellv\dot{a}g (1997) shows that the product synthesised under these conditions in the presence of excess KCl is orthorhombic zeolite N.

A process for the production of X-ray amorphous aluminosilicates or kaolin derivatives obtained by the chemical modification of clay minerals and other aluminium-bearing minerals is described in U.S. Pat. No. 6,218,329 and U.S. Pat. No. 5,858,081. In these disclosures, the modification of clay minerals to form aluminosilicate or kaolin derivatives involves the mixing of a caustic reactant in the form of an alkali halide, alkali metal halide, alkali hydroxide or alkali metal hydroxide, or combinations of these reactants, with a clay such as kaolin in the presence of water at temperatures less than 200° C. and preferably less than 100° C. As disclosed in U.S. Pat. No. 6,218,329 and U.S. Pat. No. 5,858,081, for certain reactions trace amounts of zeolite and other crystalline aluminosilicates such as kalsilite and kaliophyllite may form in addition to the amorphous aluminosilicate. However, the primary phase is an amorphous (i.e. non-crystalline) aluminosilicate.

The nomenclature for zeolites has evolved over a period of decades since the early discovery of hydrothermal synthesis routes by Barrer. The term “zeolite N” as disclosed in U.S. Pat. No. 3,414,602 and U.S. Pat. No. 3,306,922 was initially used to designate an ammonium or alkyl ammonium substituted cationic species. However, this nomenclature to describe alkyl ammonium or ammonium substituted species is no longer practised in order to avoid confusion (Szostak,1998). Sherman (1977) describes the confusion at the time with nomenclature for eleven zeolites synthesised in the K₂O—Al₂O₃—SiO₂—H₂O system and clarifies relationships for Linde F and zeolite K—F. However, zeolite N is not described in this work by Sherman (1977).

### SUMMARY OF THE INVENTION

This invention relates to the surprising discovery of a process using caustic solutions and aluminosilicates such as kaolin and/or montmorillonite which results in the production of zeolite N by a non-hydrothermal synthesis route. The invention also relates to manufacture of zeolites with the N structure of many different compositions and in forms characterized by physical properties not previously known.

In one aspect of the present invention there is provided a process for making aluminosilicates of zeolite N structure including the steps of:
(i) combining a water soluble monovalent cation with a solution of hydroxyl anions and an aluminosilicate to form a resultant mixture having a pH greater than 10 and a H₂O/Al₂O₃ ratio in the range 30 to 220;
(ii) heating the resultant mixture to a temperature of between 50° C. and the boiling point of the mixture for a time of between 1 minute and 100 hours until a crystalline product of zeolite N structure is formed as determined by X-ray diffraction or other suitable characteristic; and
(iii) separating the zeolite N product as a solid from the mixture.

Preferably the water soluble monovalent cation used in step (i) comprises an alkali metal such as potassium or sodium or ammonium ion or mixtures of these ions such as sodium and potassium. However it will be appreciated that the alkali metal may also comprise Li, Rb or Cs. Preferably the alkali metal is potassium. The solution of suitable anions may have a pH greater than 13.

If desired the resultant mixture of step (i) may also include halide ion such as chloride and in this embodiment the halide may have an alkali metal cation or monovalent soluble cation which may include potassium, sodium or ammonium or mixtures thereof such as sodium and potassium. It will also be appreciated that the alkali metal may also comprise Li, Rb or Cs. Preferably the alkali metal is potassium.

In step (i) the aluminosilicate may have an Si:Al ratio in the range 1.0 to 5.0 and more preferably in the range 1.0 to 3.0.

In step (ii) the heating step is preferably carried out at temperatures in the range 80° C. to −95° C. Preferably the reaction time is in the range 2 to 24 hours.

In step (iii) the solid product may be separated from the caustic liquor by suitable means such as, for example, by washing or filtration.

Surprisingly, zeolites of N structure are formed at low temperature (less than 100° C.) and without use of potassium chloride as an essential starting reactant as taught in the prior art. Contrary to prior art, zeolite N may be formed in the presence of caustic solutions such as KOH or NaOH although alkali halides such as NaCl may also be present.

The disclosed process enables the production of many varieties of zeolite with the N structure. In general, the compositions of zeolite N achievable by the synthesis process can be described by the formula:
(M₁₋ₐ,Pₐ)₁₂(A_{b}Si_{c})₁₀O₄₀(X_{1-d},Y_{d})₂ nH₂O where
M=alkali metal or ammonium (e.g. K, Na, NH₄); P=alkali metal, ammonium or metal cations exchanged in lieu of alkali metal or ammonium ion, X═Cl or other halide and Y═OH, halide or other anion;
for 0≦a≦1, 1≦c/b≦∝0≦d≦1 and 1≦n≦10.

Thus in another aspect of the invention there is provided novel zeolite N structures with the proviso that when a=0, b=1, c=1, d=0, X═Cl, M≠K.

As exemplified below, the method of the invention may give rise to potassium-only, potassium and sodium, potassium and ammonium and potassic high silica forms of zeolite N. Surprisingly, other forms of zeolite N produced by the disclosed invention include a potassium-only form with hydroxyl ion as the anion rather than chloride. These compositional variants have common properties arising from the method of production as described below. Other compositional variations to the forms described below are possible as will be appreciated by those skilled in the art.

Zeolites of this invention display a characteristically high proportion of external surface area (with values greater than 5 m²/g), a distinctive X-ray diffraction pattern as shown in FIGS. 2, 5 and 6 and a high selectivity to ammonium and certain metal ions in the presence of alkali metal and alkaline earth ions in solution. In a powder X-ray diffraction pattern, the product of this process to make zeolite N shows a high background between the region 25°<2θ<35°. This high background intensity which ranges between 5% and 15% of the maximum peak height, may extend beyond 2θ=35° up to 2θ=70°. This high background intensity is not observed In prior art on hydro-thermally synthesised zeolite N and suggests the presence of nano-sized crystals and/or amorphous aluminosilicate in association with zeolite N.

Without wishing to be bound by theory, the attributes of zeolite N formed by the process of this invention and the proximity of amorphous aluminosilicates (as described in U.S. Pat. No. 6,218,329 and U.S. Pat. No. 5,858,081) to zeolite N in the phase diagram shown in FIG. 1 suggest that amorphous aluminosilicate derivatives of kaolin (or of montmorillonite) are an intermediate or transitory phase in the production of zeolite N by this process and thereby imparts physical properties that cannot be developed through conventional hydrothermal synthesis.

The disclosed process results in aluminosilicates of zeolite N structure possessing the following properties:
(a) high selectivity for exchange of ammonium ions (ranging from 75% to 100%) in the presence of alkali metal and/or alkaline earth ions in aqueous solutions with a wide range of pH values, especially in comparison to other zeolites with Si:Al˜1.0
(b) high selectivity for exchange of metal ions (ranging from 30% to 100%) such as copper, cadmium, zinc, nickel, cobalt and lead in the presence of alkali metal and/or alkaline earth ions in aqueous solutions with a wide range of pH values, especially in comparison to other zeolites with Si:Al˜1.0
(c) BET surface area values greater than 1 m²/g, preferably greater than 5 m²/g and less than 150 m²/g
(d) a high proportion of external surface area to internal surface area especially compared with other zeolites with Si:Al˜1.0
(e) capacity to absorb ammonia gas between 0° C. and 300° C.
(f) absorption capacity for oil ranging from 50 m/100 g to 150 g/100 g,
(g) compositions with ratios of silicon to aluminium ranging from 1.0 to 5.0 preferably from 1.0 to 3.0,
(h) cation exchange capacity ranging from 100 meq/100 g to 700 meq/100 g, preferably greater than 200 meq/100 g for ammonium ions in solution with concentrations between less than 1 mg/L to greater than 10,000 mg/L,
(i) when in an ammonium-exchanged form, capacity to re-exchange alkali metal ions from caustic solutions (e.g. NaOH or KOH) ranging in concentration from 0.1 M to 2.0 M, preferably between 0.4 M and 1.5 M
(j) removal rate of ammonium ranging between 50% and 100%, preferably between 90% and 100%, from ammonium-loaded zeolite N using a caustic only regenerant solution and
(k) capacity to re-exchange ammonium ions and/or retain high selectivityfor ammonium ions after regeneration with a caustic only solution.

Many of these properties, having been disclosed for zeolite N of this invention, may also be attributable to zeolite N of the prior art or zeolite N formed by other processes. However properties (c), (d) and (f) are believed to be only applicable to zeolite N of the present invention.

### BRIEF DESCRIPTION OF THE DRAWINGS

Reference is now made to non-limiting embodiments of the present invention described by way of example with reference to the accompanying figures and tables.

FIG. 1: Ternary diagram showing formation of zeolite N in relation to sodalite and kaolin amorphous derivative under similar reaction conditions. The zeolite N phase field is delineated by solid lines. The region between the dotted line and solid line is the approximate location for formation of amorphous aluminosilicates.

FIG. 2: Typical X-ray powder diffraction pattern for potassium-formed zeolite N (Example 7) with all intensities normalised to Iₘₐₓ=100. All peaks are indexed to the unit cell of zeolite N in space group I222; key reflections are indicated on the figure.

FIG. 3: X-ray powder diffraction pattern for amorphous aluminosilicate as described in Example 18. Reflections for residual (un-reacted) kaolin are denoted by “K”.

FIG. 4: Comparison of H₂O/Al₂O₃ ratio and cation ratio for zeolite N (diamonds) and sodalite (squares) formed by the disclosed process and zeolite N formed by prior art (triangle; Christensen and Fjelvag, 1997). Note that the temperature of formation for zeolite N of prior art is 300° C.

FIG. 5: X-ray powder diffraction pattern for zeolite N formed by the method described in Example 9. Peaks related to minor quartz are denoted “Qtz”. Key reflections are indicated on the figure.

FIG. 6: X-ray powder diffraction pattern for zeolite N from Example 10. Key reflections are indicated on the figure.

FIG. 7: Comparative X-ray diffraction patterns for (a) amorphous aluminosilicate, (b) intermediate stage containing both amorphous aluminosilicate and zeolite N and (c) zeolite N as noted in detailed description.

FIG. 8: Dependence of cation exchange capacity (CEC) with time of reaction for the method(s) described in Example 1 and Example 2.

FIG. 9: Comparative loading capacities for zeolite N (filled symbols), zeolite A (open squares) and clinoptilolite (open circles) (a) in the presence of calcium ions as described In Example 22 and (b) In the presence of sodium ions as described in Example 24.

FIG. 10: Comparative regeneration capacities for mixtures of NaOH and NaCl used over three cycles for zeolite N as described in Example 24.

FIG. 11: Comparative regeneration capacities for mixtures of NaOH and Na₂CO₃ for one regeneration cycle for zeolite N as described in Example 24.

FIG. 12: Comparative regeneration capacities for NaOH only at different molarities used over two cycles for zeolite N as described in Example 24.

FIG. 13: Reduction in ammonium ion concentration for a fixed bed of zeolite N and zeolite A at a flow rate of 4.5 BVhr⁻¹ for an ammonium-rich water as described in Example 25.

FIG. 14: Reduction In ammonium ion concentration for a fixed bed of zeolite N and zeolite A at a flow rate of 2.25 BVhr⁻¹ for an ammonium-rich water as described in Example 25.

FIG. 15: Reduction in ammonium ion concentration for a fixed bed of zeolite N and clinoptilolite at a flow rate of 29 BVhr⁻¹ for an ammonium-rich water over two loading cycles and one regeneration cycle as described in Example 26.

FIG. 16: Reduction in ammonium ion concentration for a fixed bed of zeolite N and clinoptilolite at a flow rate of 2 BVhr⁻¹ for an ammonium-rich water from a anaerobic digester side stream as described in Example 27.

FIG. 17: Reduction in ammonium ion concentration for a fixed bed of zeolite N at a flow rate of 5 BVhr⁻¹ and 10 BVhr⁻¹ for an ammonium-rich water from a sewage treatment plant as described in Example 28.

FIG. 18: Reduction in ammonium ion concentration for a fixed bed of zeolite N at a flow rate of 4 BVhr⁻¹ for an ammonium-rich water from a landfill site over two loading cycles and one regeneration cycle as described in Example 29.

FIG. 19: Comparative metal ion selectivity over calcium ions for zeolite N and zeolite A as described in Example 33.

FIG. 20: Reduction in nitrogen leaching from a sandy soil profile for various applications of zeolite N as described in Example 34. The control (i.e. 0 T/ha) is for no application of zeolite N and shows typical nitrogen leaching rates for sandy soils when liquid fertilisers are used.

### DETAILED DESCRIPTION OF THE INVENTION

Zeolite N Synthesis

Table 1 refers to a comparison of reaction conditions for selected zeolites produced by prior art. Table 1 shows that Barrer et al. (1953) did not produce high yields of zeolite N, but rather, produced mixtures of kalsilite and zeolite N or leucite and zeolite N. In their work, Barrer et al. (1953) used high temperatures (450° C.), long times (1-2 days) and high quantities of water and potassium salt to produce a potassium-only zeolite N. Barrer and Marcilly (1970) used a stoichiometric amount of KOH and a high excess of KCl but did not produce a zeolite N from a kaolin starting material. Christensen and Fjellv\dot{a}g (1997) use an excess of KCl with a sodium aluminosilicate zeolite to produce zeolite N of composition K₁₂Al₁₀Si₁₀O₄₀Cl₂.8H₂O.

In particular, the present invention produces a form of zeolite N which is broader in scope that that produced by Christensen and Fjellv\dot{a}g (1997) as will be apparent from the foregoing. The present invention surprisingly produces a form of zeolite N by mechanical mixing of different reactants, individually or in combination, over a wide range of concentrations at ambient pressures below 100° C. The present invention offers many starting reactants to produce many different compositions of zeolite with the N structure. Examples of starting compositions for specific reaction conditions to produce zeolite N in accordance with the invention are given in Table 2. Aluminosilicates such as kaolin or montmorillonite are preferred starting materials for the present invention.

Once the product is formed, additional procedures for manufacture may comprise
i. washing of the zeolite N product to remove excess salts followed by subsequent drying of the solid product
ii. re-use of the caustic liquor as part of a caustic solution for subsequent production of additional zeolite N by the same process and
iii. re-use of the washing solution for subsequent production of zeolite N by the same process.

In contrast, prior art teaches the use of hydrothermal synthesis in a static mixture using an autoclave to enhance crystallisation from an aluminosilicate gel or zeolite A. Zeolite N of a specific composition is formed by one specific ratio of reactants in the prior art (Christensen and Fjellv\dot{a}g, 1997).

In Table 2, specific examples of the present invention (Examples 1, 4, 5, 6, 7, 9, 10, 11 and 12) are compared with prior art for production of zeolite N (Christensen and Fjellv\dot{a}g, 1997). Table 2 shows that reaction parameters by which this synthesis procedure are described such as K₂O/Al₂O₃, KCl/Al₂O₃, H₂O/Al₂O₃, Na₂O/Al₂O₃, NaCl/Al₂O₃, Cl/SiO₂, K/(K+Na) and (K+Na−Al)/Si (i.e. in their totality), are markedly different from prior art.

Preferred ratios of reagents for the potassic and sodic compositions of zeolite N by the disclosed process over the temperature range 80° C. to 95° C. may comprise
(a) K₂O/Al₂O₃ between 0.3 and 15.0,
(b) KCl/Al₂O₃ between 0.0 and 15.0,
(c) Na₂O/Al₂O₃ between 0.0 and 2.5,
(d) NaCl/Al₂O₃ between 0.0 and 2.8,
(e) Cl/SiO₂, between 0.0 and 6.5,
(f) K/(K+Na) between 0.5 and 1.0 and
(g) (K+Na−Al)/Si between 2.0 and 18.0, preferably between 3.0 and 11.0.

Similar ratios of other reagents may also be used under similar circumstances to produce the appropriate compositional form of zeolite N.

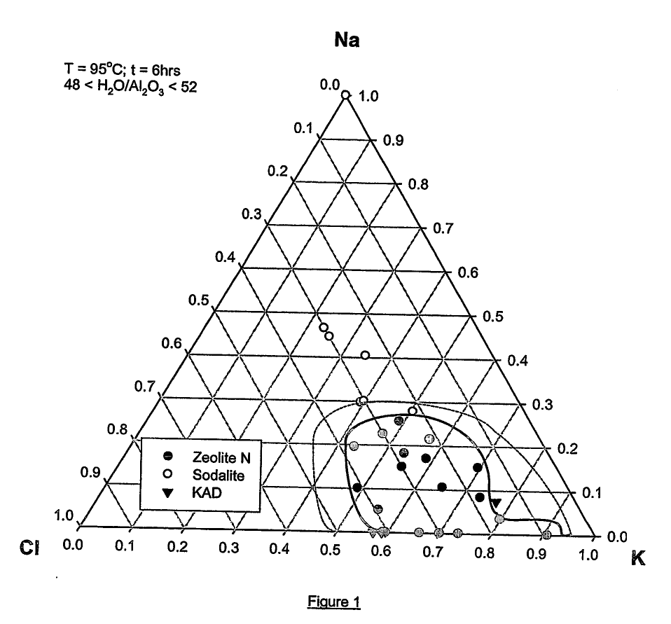

In contrast, Examples 15 and 16 (also summarised in Table 2) show the outcome for synthesis conditions using the methods of the present invention (i.e. mechanical agitation at ambient pressure at T<100° C.) for the starting composition proposed by Christensen and Fjellv\dot{a}g (1997; Example 15) and for similar H₂O/Al₂O₃ ratio used to define the phase diagram in FIG. 1 (Example 16). In both cases, the product is zeolite A rather than zeolite N.

Phase Diagram

Systematic evaluation of reaction variables for a specific temperature (e.g. 95° C.) and water content (e.g. 48<H₂O/Al₂O₃<52) and characterisation of the product(s) shows that the formation of zeolite N by the present invention may be described by the ratios of reagents in the mixture. FIG. 1 shows a ternary phase diagram for zeolite N production defined by the major components K, Na and Cl. The data in FIG. 1 are for a reaction temperature of 95° C. for 6 hours.

The stability field for zeolite N formation will vary with temperature and water content but over a range of values will remain substantially as described in FIG. 1. For example, at lower temperature of reaction, the phase field broadens in comparison to that shown in FIG. 1. Evidence for this is given in Example 10 in which the formation of zeolite N occurs at K=1.0 at a temperature of 90° C. For comparison, the prior art process by Christensen and Fjellv\dot{a}g (1997) cannot be plotted on this ternary diagram.

As exemplified in FIG. 1, other phases may form if the conditions differ from the broad process of the present Invention. For example, if the sodium content in a reaction mix is high, sodalite may form. Alternatively, potassium-rich phases such as kaliophyllite or kalsilite may form outside the conditions delineated for the present invention. The formation of aluminosilicate derivatives or kaolin amorphous derivatives—as described in U.S. Pat. No. 6,218,329 and U.S. Pat. No. 5,858,081 (designated “KAD” in the ternary diagram)—may also occur outside the conditions for formation of zeolite N of this invention.

The relationships between these phases—sodalite, zeolite N and KAD—are demonstrated in FIG. 1. A representative X-ray powder diffraction pattern for zeolite N of the present invention is shown in FIG. 2 (data for Example 7). Note the relatively high background intensity (between 5% and 10% of maximum peak height) common to these forms of zeolite N.

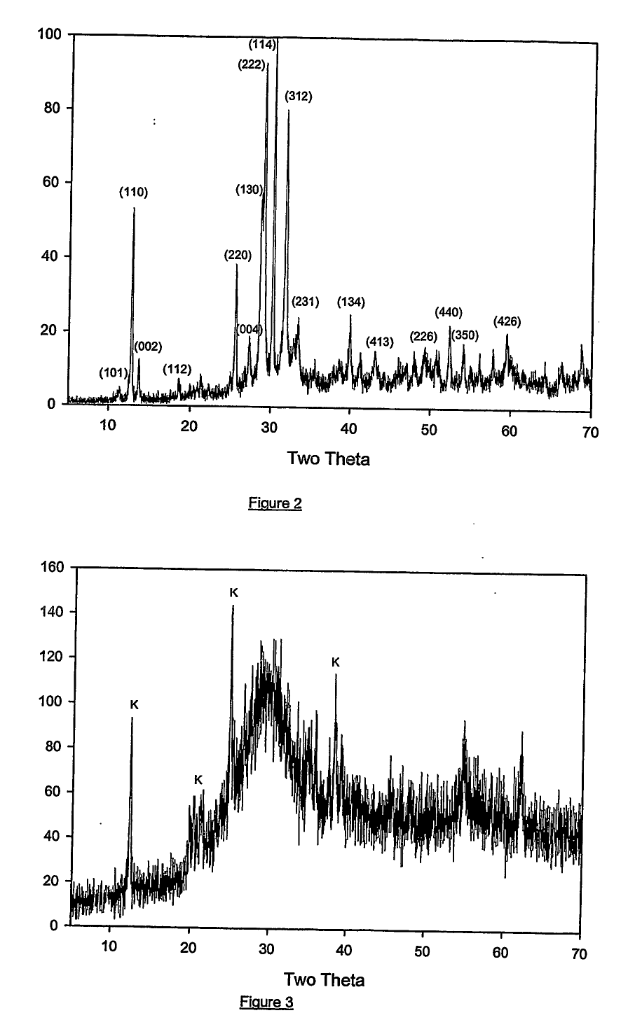

The region between the dotted and solid lines in FIG. 1 defines approximately the formation conditions for materials previously described in U.S. Pat. No. 6,218,329 and U.S. Pat. No. 5,858,081. Example 18 demonstrates that—in comparison to the form of zeolite N of this invention—amorphous aluminosilicates form in that segment of the phase diagram shown in FIG. 1 as “KAD”. For reference, an X-ray diffraction pattern of this amorphous aluminosilicate as described in Example 18 is shown in FIG. 3.

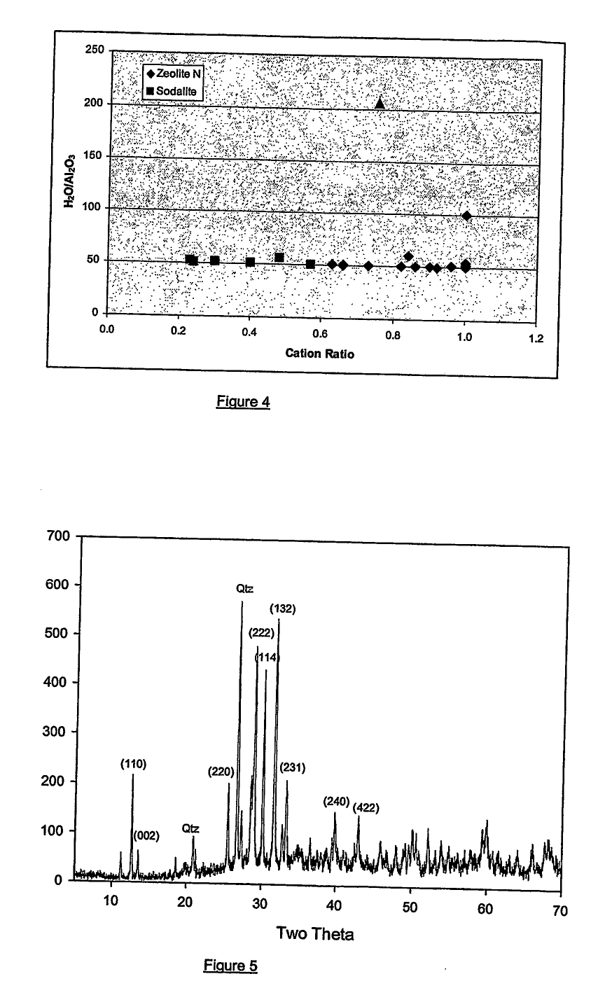

FIG. 4 is a phase diagram showing H₂O/Al₂O₃ versus cation ratio for the formation of zeolite N and sodalite for reaction temperature of 95° C. and time of six hours. In this figure, data from the present invention are plotted as diamonds, sodalite as squares and the prior art from Christensen and Fjellv\dot{a}g (1997) as a triangle. Reaction parameters for zeolite N of the present invention are significantly different to that of prior art and lies at higher cation ratio values compared with sodalite. FIG. 4 highlights the wide difference in water content between conventional hydrothermal synthesis and the method described in this disclosure for zeolite N production.

Zeolite N Structure and Compositions

Zeolite N is classified within the EDI type framework as defined by the international zeolite association (www.zeolites.ethz.ch/zeolites). The composition of Zeolite N according to the study by Christensen and Fjellv\dot{a}g (1997) is K₁₂Al₁₀Si₁₀O₄₀Cl₂.8H₂O. Compositional variations on this formula defined by Christensen and Fjellv\dot{a}g (1997) have not been disclosed for zeolite N in the prior art.

The products of the present invention include a wide variety of compositions which are determined by the starting compositions represented, for example, by the phase diagrams shown in FIGS. 1 and 4. Another aspect of the invention is the surprising production of different compositional forms of zeolite N through the procedure of the present invention. The compositional forms produced by this novel non-hydrothermal synthesis route include those described in Table 3 and thus, extend the suite of zeolite N materials formed by hydrothermal and non-hydrothermal synthesis routes. Specific examples of synthesis related to each compositional form are given in Table 3.

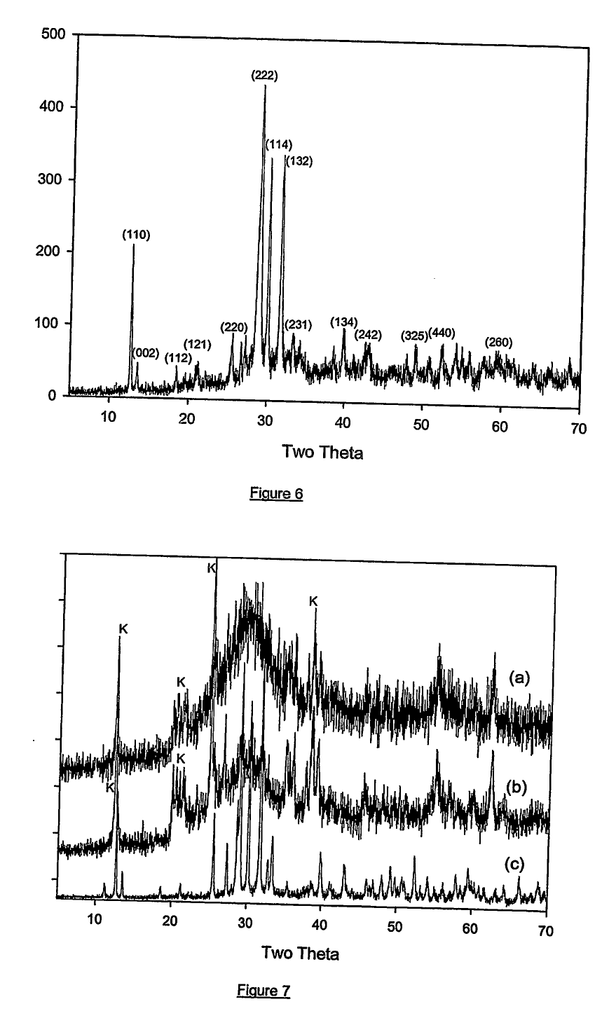

An X-ray powder diffraction pattern for zeolite N of the present invention with high Si:Al ratio derived from montmorillonite (Example 9) is shown in FIG. 5. Bulk chemical analysis and calculation of product stoichiometry suggest that Mg and/or Fe may be incorporated into the structure. As noted in Table 3, stoichiometric evaluation of bulk chemical analyses for products of this process suggest the presence of other ions (such as OH and/or NO) within the zeolite N structure. A form of zeolite N of the present invention in which OH ion replaces the Cl ion within the structure is given in Example 10. An X-ray powder diffraction pattern for this zeolite N is shown in FIG. 6.

A set of indexed reflections for Examples 9, 10 and 11 are compared with indices determined by Christensen and Fjellv\dot{a}g (1997) in Table 4. Variations in the intensity of key reflections in the regions 11.0°<2θ<13.6° and 25°<2θ<35° are manifestations of the different compositional variants compared to the potassium-only form identified by Christensen and Fjellv\dot{a}g (1997).

X-ray powder diffraction patterns for all examples identified as zeolite N in this description follow the type patterns shown in FIGS. 2, 5 and 6 and the data shown in Table 4. Materials produced with these characteristic X-ray diffraction patterns are encompassed within this invention.

Recycling of Caustic Solution during Synthesis

For the present invention, recycled caustic reagent may be repeatedly used to produce high yield of zeolite N. The quantity of caustic liquor available for recycling after the initial reaction is dependent upon the efficiency of solid-liquid separation technique used. The efficiency of filter pressing, centrifugation or other such separation techniques will be appreciated by those skilled in the art.

Comparison of the caustic usage for the production of an equivalent mass of zeolite N as a result of (a) no recycle of caustic and (b) caustic recycle is summarised in Table 5. For Example 1 and the use of caustic recycle shown in Example 2, the quantity of caustic used with recycled liquor to produce 783 kg of zeolite N is reduced to 61% of the quantity used in reactions without recycle. The caustic to product ratio is reduced to the values shown in Table 6 when up to eight times recycle of the liquor is included in the manufacturing process. A greater or lesser number of recycling steps can be implemented with similar outcome(s) to that provided in the examples below.

Such high proportions of caustic liquor recycle are not evident for hydrothermal synthesis methods of zeolites, particularly those with 1<Si/Al<3.

Re-use of the separated caustic liquor after reaction to form zeolite N of this invention is not limited to potassic forms of caustic reagents or their mixtures inasmuch as sodic or other suitable forms of caustic reagent, their mixtures (for example, sodium hydroxide and sodium chloride) and mixtures with potassic or other alkali forms are suitable candidates.

Properties of Zeolite N

A summary of bulk properties for zeolite N of the present invention is shown in Table 6. This table shows that cell dimensions, bulk composition, cation exchange capacity (CEC) and BET surface area will vary depending on the starting chemistry of the disclosed process. However, all properties remain within the broad range of values for each parameter defined in the claims of this invention. For example, with a higher Si/Al ratio, the CEC value for Example 9 is lower than achieved for zeolite N formed by the processes described in Examples 1 and 4. This difference in CEC value is related to the Si/Al ratio of the resulting product. In both cases, the CEC value approaches the theoretical limit for an aluminosilicate of the respective Si:Al ratio.

The ion-exchange behaviour in zeolites is complex and not completely understood (Weitkamp and Puppe, 1999) and without wishing to be bound by theory, ion-exchange kinetics and selectivity is related to a combination of factors including zeolite pore size, zeolite pore shape, the hydrophilicity or hydrophobicity of the zeolite framework and the electrostatic potential in zeolite channels.

Yet another aspect of this invention is the production of compositional varieties of zeolite N by room temperature ion-exchange in an aqueous solution. Ion-exchanged forms produced from the present invention include those described in Table 3.

Element substitution via exchangeable cations in the zeolite N structure of the present invention include: sodium, ammonium, copper, zinc, nickel, cadmium and silver for potassium and/or sodium and/or ammonium (Examples 19,20,33 and 35). X-ray diffraction patterns of these exemplifications demonstrate that zeolite N is formed by the methods described herein.

The proportion of external or internal exchange sites present in an aluminosilicate framework influences exchange behaviour in small pore zeolites. Conventional zeolites comprising micrometre-sized particles typically contain the majority of exchange sites in the internal channels with only a small percentage of the exchange sites present on the external surface.

For example, for a spherical zeolite particle of 1 micron diameter the external surface area is approximately 3 m²/g whereas the internal surface area may be 500 m²/g or more. In this case, the external surface area represents less than 1% of the internal surface area. This is generally the case for hydro-thermally synthesised zeolites of small Internal pore size (i.e. <0.38 nm) and, it is speculated, applies to the form of zeolite N of the prior art.

Alternatively, nano-crystalline zeolites contain a much greater fraction of external surface sites and, for zeolites of small internal pore size, this is reflected in the surface area measurements determined by conventional BET methods. For example, 100 nm-sized zeolite particles have an external surface area approximately 30 m²/g.

The small internal pore sizes for zeolite N (ranging from 0.28 to 0.30 nm in effective diameter) preclude the measurement of internal surface area by conventional adsorption of nitrogen gas at liquid nitrogen temperatures (the standard BET method) as the kinetic diameter of nitrogen gas is 0.368 nm. Thus, the surface area for zeolite N measured by the BET method is the area of the external zeolite surface. The external surface areas for zeolite N of the present invention are listed for Examples 1 to 20 in Table 6.

The BET surface area for zeolite 4A, a structure also with a small internal pore size, is less than 2.5 m²/g. A comparison with products of the present invention shows that in all cases, the external surface area for zeolite N is greater than hydro-thermally synthesised zeolite 4A. For zeolite N of the present invention, surface area values are greater than 5 m²/g and in some cases are significantly higher at 55 m²/g and 100 m²/g. These surface area values imply that the primary particle size is sub-micrometer in dimension and that the bulk of the products formed by the disclosed process are nano-crystalline. Electron microscopy on the products of the present invention confirms that primary particle sizes range between 50 nm and 500 nm in two dimensions. Zeolite N of the present invention commonly forms laths although other morphologies are possible.

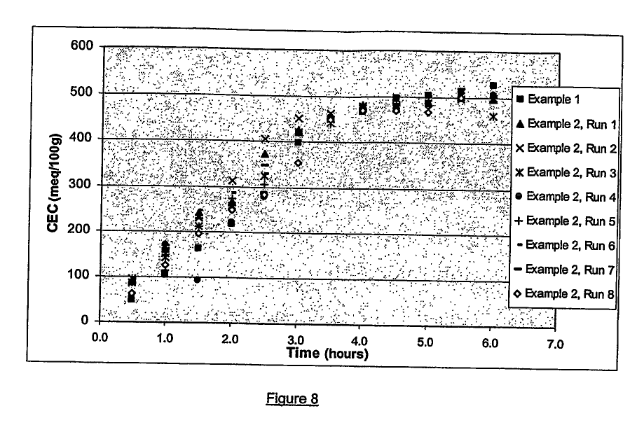

A possible link between the amorphous aluminosilicate represented by the X-ray diffraction pattern in FIG. 3 and the zeolite N of this invention is summarised by the three patterns shown in FIG. 7. The three X-ray diffraction patterns show (a) amorphous aluminosilicate as described in Example 18, (b) a combination of amorphous aluminosilicate and minor amounts of zeolite N of this invention and (c) zeolite N of this invention as described in Example 8. Each material in FIG. 7 has been prepared by the methodology described in this invention but with starting compositions that represent three different positions on the phase diagram in FIG. 1.

In this figure, residual (un-reacted kaolin) peaks are marked “K”. A close relationship between the key basal spacings of the starting clay (e.g. the (001) reflection of kaolin) and key peaks (e.g. the (110) reflection) of zeolite N of this invention is apparent. Similarly, the (002) reflection for kaolin at d˜3.57 A is closely related to the (220) reflection of zeolite N of this invention.

While not wishing to be bound by theory, these similarities in d-spacings for key reflections imply a re-arrangement of atoms within a Si—Al network resulting in key spacings within the zeolite N structure. In addition, the similarity of structural data implies a transformation to the zeolite N structure from kaolin (or montmorillonite or other aluminosilicate) via an intermediate phase which may be the amorphous aluminosilicate described in U.S. Pat. No. 6,218,329 B1 and U.S. Pat. No. 5,858,081 and reproduced in Example 18.

Indirect support for this interpretation is revealed in the higher than expected background intensity for X-ray powder diffraction patterns when normalised against a calibration standard such as quartz. With normalisation, background intensities range from 5% to 15% of maximum peak height in powder X-ray diffraction patterns of zeolite N of the present invention. In comparison, the diffraction pattern described by Christensen and Fjellv\dot{a}g (1997) shows background intensity less than 1% of the peak height as is common for hydro-thermally crystallised zeolites.

As disclosed in Example 21, the ammonium exchange capacity for zeolite N is higher than other zeolitic materials. Thus, zeolite N is a suitable material for the removal of ammonium ions in water or wastewaters. Comparisons of ammonium removal using other zeolites with Si:Al˜1.0 and with natural zeolites such as clinoptilolite demonstrate that zeolite N is a superior material for this purpose.

Examples 22 and 23 show that zeolite N as disclosed in Examples 1 and 19 shows higher ammonium ion selectivity than zeolite A or clinoptilolite in the presence of a single alkaline earth or alkali metal ion (e.g. Ca²⁺ or Na⁺ as disclosed in Example 22) or mixtures of alkaline earth ions (e.g. Ca²⁺ and Mg²⁺ as disclosed in Example 23). Surprisingly, zeolite N has a much higher selectivity for ammonium in the presence of a high sodium ion concentration than zeolite A.

Other instances of higher selectivity for ammonium in the presence of many competing ions (such as potassium, sodium, calcium and magnesium) are described in Examples 27,28,29 and 30. Granulated forms of zeolite N similarly show higher loading capacity and higher selectivity for ammonium ions compared with granulated forms of zeolite A or clinoptilolite (as disclosed in Examples 25, 26 and 27) over a wide range of ammonium ion concentrations.

Furthermore, Examples 27 and 28 show that zeolite N is an effective material for the removal of ammonium ion in sewage treatment plants and Example 38 shows that anions may be absorbed from wastewaters using zeolite N. Data from Example 29 show that zeolite N removes ammonium from landfill leachate. Examples 24,26 and 29 show that the capacity of zeolite N for ammonium removal is retained or higher than the first loading cycle after regeneration using a caustic only solution.

Example 39 shows that zeolite N absorbs oil at capacities greater than other aluminosilicates such as attapulgite, zeolites X and P and bentonite.

If zeolite N is loaded with ammonium Ions, removal of the ammonium species and regeneration of material can be achieved by re-exchange with a solution comprising alkali ions such as sodium. However, the use of salt solutions may not be chemically efficient for many zeolite types and the resultant brine solution can be difficult to dispose or re-use in an environmentally responsible and cost-effective manner.

Zeolite N of this invention can be regenerated by any of the known means in the prior art and, as shown in Examples 24, 26 and 29, is amenable to regeneration by means of solutions comprising only sodium hydroxide. This latter behaviour is in contrast to previously disclosed literature which advocates the use of sodium chloride based solutions. Furthermore, a 1.2M NaOH regenerant solution provides high efficiency of ammonium capture when used on ammonium-loaded zeolite N. In contrast, and as disclosed in Example 26, clinoptilolite ammonium removal performance is degraded substantially after regeneration with a 1.2M NaOH solution.

Zeolite N exchanges with a range of cationic species such as transition metals (including but not limited to Cu, Zn, Ni, Co) and heavy metals (including but not limited to Cd, Ag and Pb) as described in Examples 33 and 37. Similar exchange will occur for lanthanides and actinides with zeolite N of this invention. Zeolite N may be in the form of a powder or as a pellet or granule. Any soluble salt of the cation to be exchanged with zeolite N can be employed; examples include metal chlorides, nitrates or sulphates.

This invention relates to use of zeolite N (prepared as disclosed in Example 1) through exchange with anti-microbiologically active ions such as zinc, copper and silver (as described in Example 33). The method of preparation of the zeolite N material with antimicrobial ions can be varied in accord with the following limitations. The identity of the silver, copper or zinc precursor species is not critically Important provided the precursor salt is soluble in water.

For instance, nitrate salts are very soluble and easy to use and other salts are available for use.

Co-exchange of silver and/or copper and/or zinc and/or ammonium ions together with zeolite N can provide an effective multi-purpose antibacterial material as disclosed in Example 35. Zeolite N has exceptional capacity for ammonium ions and, without wishing to be bound by theory, it is proposed that the ammonium ions may help avoid discoloration of the zeolite when in use. Drying of the co-exchanged material is performed at a temperature less than 400° C., preferably less than 250° C. and more preferably at a temperature less than 150° C.

The loading rates for ammonia gas absorption for Zn— and Ag-exchanged zeolite N are described in Example 37. in these examples, ammonia gas is absorbed in the presence of water and other gases at temperatures greater than 50°0 C. The loading of ammonia gas onto metal-exchanged zeolite N is effective at a range of temperatures from 0° C. to 350° C. Data in Table 13 for Example 37 show that loading rates greater than 30 g NH₃ per kg of zeolite N can be achieved at temperatures higher than 80° C. for gas streams containing between 8% and 30% water, between 10% and 15% CO₂ and 1,000 ppm NH₃.

Similarly, proton-exchanged zeolite N of this invention absorbs ammonia gas. Alkali-exchanged zeolite N is exchanged with a solution of ammonium species until approximately 100% exchange is achieved. Subsequently, the ammoniumexchanged zeolite N is heated to decompose the ammonium species to protons without loss of zeolite N structure. A temperature of 300° C. for a period of at least several minutes is sufficient to decompose the majority of the ammonium species while minimising the extent of dehydroxylation and maximising the formation of proton-exchanged zeolite N.

If zeolite N is loaded with adsorbed ammonia gas, a means of regeneration is by thermal swing desorption. This regeneration involves heating ammonia-loaded zeolite N material in an atmosphere such as air or inert gas to a temperature sufficient to desorb the ammonia. The temperature required for desorption depends upon the identity of the exchangeable ion on the zeolite N framework and can be found by techniques such as, but not limited to, temperature programmed desorption (TPD), differential thermal analysis (DTA) or thermogravimetric analysis (TGA).

Preparation of surfactant modified zeolite N can be achieved by any of the known methods in the prior art. The basic principle involves contacting zeolite N with an aqueous solution of the surfactant species for sufficient time to obtain optimum exchange of the surface sites on the zeolite. Quaternary amine salts are species of choice and examples of these compounds include hexadecyltrimethylammonium (HDTMA), benzyltrimethylammonium chloride (BTMA), tetraethylammonium bromide (TEA), benzyldimethyltetradecylammonium (BDTMA), tert-butyl ammonium bromide, hexadecylpyridinium (HDPY), tetramethylammonium (TMA), trimethylphenylammonium (TMPA) and dioctodecyldimethylammonium (DODMA). Naturally, there exist many other suitable surfactants to modify the surface of the zeolite N material.

The present invention relating to the process to make zeolite N offers the following advantages:
1. high yields of zeolite N (achieves >90%) in large volume production
2. temperature of reaction is low (i.e. <100° C.) and reaction times are short
3. volumes of solution required are low
4. feed liquor can be supplemented by recycled liquor from a previous batch of zeolite N production and
5. feed liquor can be supplemented by recycled wash water from a previous batch of zeolite N production.

Zeolite N made by the process of the present invention provides the following advantages:
1. a hydrophilic material with excellent selectivity for ammonium ion exchange in the presence of alkali metal and alkaline earth ions compared with existing aluminosilicates
2. a hydrophilic material with exceptional capacity to exchange ammonium ions from solutions compared with other existing aluminosilicates
3. capacity to be formed into granules suited to fixed bed exchange columns for ion exchange of alkali metal, alkaline earth, ammonium, transition metal, rare earth and actinide metal ions
4. capacity for continuous re-use through cyclic regeneration of the material (as granules and/or as powders) using a caustic only solution such as NaOH or KOH or mixtures thereof
5. improved capacity to remove ammonium ion from solutions compared with existing aluminosilicates such as zeolites 4A, clinoptilolite and bentonite
6. improved capacity to remove metal ions from solutions compared with existing aluminosilicates such as zeolites 4A, clinoptilolite, bentonite and kaolinite
7. improved capacity to absorb oil compared with existing aluminosilicates such as zeolites 4A, X, P, bentonite and kaolinite
8. capacity to co-exchange alkali metal, metal and/or ammonium ions to form a selectively exchangeable material useful for agricultural, antibacterial and other applications
9. capacity to exchange metal, ammonium or hydronium ions for adsorption of ammonia gas
10. capacity to exchange metal, ammonium or hydronium ions for adsorption of ammonia gas from gas flows which contain water
11. capacity to adsorb complex compounds to impart a hydrophobic character
12. capacity to capture anions from solution.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Standard Procedures

For zeolite N reactions at bench and pilot plant scale, stainless steel reactors equipped with (i) a mixing blade, (ii) an external heating coil with thermocouple and (iii) a loose-fitting cover have been employed. For many reactions at scales >600 g, samples of the mix are extracted during the reaction in order to measure standard parameters. Measurements of pH for these reaction mixtures are obtained from samples held between 60° C. and 65° C.

Methods for characterisation of solid products include X-ray powder diffraction, surface area analysis, bulk elemental analysis and cation exchange capacity for ammonium ion. X-ray data were collected on a Bruker automated powder diffractometer using CuKα radiation (λ=1.5406) between 5° and 70° 2θ at a scan speed of 1° 2θ per minute using quartz as a calibration standard. The International Centre for Diffraction Data files were used to identify major phases in all samples. Cell dimensions for zeolite N samples were obtained by least-squares refinement from X-ray powder diffraction patterns. Least-squares refinements on cell dimensions require a two-theta tolerance of ±0.1° (i.e. difference between observed and calculated reflections) for convergence.

Surface area measurements were obtained on a Micrometrics Tri-Star 3000 instrument using the BET algorithm for data reduction and standard procedures for adsorption and desorption of nitrogen. Bulk elemental analyses for major elements were obtained by inductively coupled plasma spectroscopy (ICP) using standard peak resolution methods.

Cation exchange capacities were determined experimentally for equilibrium exchange of ammonium ion in a 1M NH₄Cl solution. The procedure for determination of experimental CEC values described in this work is as follows:

0.5 g of the material is dispersed into 25 ml of RO water and centrifuged at 3,000 rpm for 10 minutes. After decanting the supernatant for measurement of potassium ions, 30 ml of 1M NH₄Cl is added in solution to the samples, shaken to disperse particles and allowed to agitate for a period of 16 hours. The equilibrated solution is then centrifuged at 3,000 rpm for 10 minutes and the supernatant solution discarded. Yet again, 30 ml of 1M NH₄Cl solution is added and the solids dispersed by shaking and agitated for two hours. Repeat this process for ammonium exchange a further time. Following the third centrifuge event 30 ml of absolute ethanol is added to wash the sample, mixed and then centrifuged for 10 minutes. The ethanol wash process is repeated using an additional 30 ml of absolute ethanol a further two times. Subsequently, 30 ml of 1M KCl solution is added to the samples and agitated for a period of 16 hours. The samples are then centrifuged for 10 minutes and the supernatant decanted into a clean 100 mL volumetric flask. Again, 30 ml of 1M KCl solution is added to the solid sample, shaken and agitated for two hours. Repeat centrifuge, decant into clean 100 mL flasks, add KCl solution and agitate a further two times. Make up each of the volumetric flasks with decanted supernatant to 100 ml with 1M KCl solution. Finally, all samples are analysed for ammonium ion concentration using the method by Kjeldahl (steam distillation). The cation exchange capacity for each sample is then calculated from these data.

This method for CEC determination when used on a well-known clay material (Cheto montmorillonite, AZ, Clay Minerals Society Source Clays SAz-1; van Olphen and Fripiat, 1979) as an internal calibration standard gives a CEC value of 98.1±2.5 meq/100 g (54 analyses over a period of eighteen months). This value is consistent with the value for potassium exchange on SAz-1 of 100±2 meq/100 g determined by Jaynes and Bingham (1986). If not identified to the contrary, CEC values determined for the material(s) exemplified in this work are on a “wet weight” basis (ie. no correction for dry weight of the material). CEC values determined on a dry weight basis use the same protocol as given above but with samples dried at 105° C. overnight prior to dispersion in water for measurement of potassium ions.

For applications of zeolite N in practice, it may be necessary to granulate the powder into a form which is amenable for use in, for example, a fixed bed configuration in a column. The granulation process includes mixing zeolite powder with a suitable binder material, subsequent forming into a viable shape such as a spherical or elongate granule and then calcining the material to impart physical strength. Those skilled in the art will be aware of many methods and approaches to form granules of zeolitic material. The identity of the binder is not particularly limited and common materials such as clays, polymers and oxides may be used. For example, sodium silicate (“water glass”) addition at levels up to 20% is an effective means to produce granules with suitable mechanical properties. It is desirable to use the least amount of binder suited to the purpose so that the cation exchange capacity of zeolite granules is maximised. Calcination of zeolite N is preferably carried out at temperatures below 600° C. and it is more preferable to calcine at temperatures less than 550° C.

The success of ion exchange methods in a fixed bed depends upon a range of engineering criteria which should be considered when using zeolite N. The size distribution of zeolite granules and the bulk density have an impact upon the effective ammonium ion exchange capacity (Hedström, 2001). In addition, hydraulic residence time (or flow rate) and inlet water composition (e.g. pH, TDS, ammonium ion concentration) influence the outcome of fixed bed exchange reactions. In the comparative examples used for this disclosure, similar sized granules (typical range between 1.6 mm and 2.5 mm) and similar operating conditions have been used in order to provide clear evidence for the superior performance of zeolite N for wastewater treatment.

The test for linseed oil absorption is described as follows: 5 g of material is kneaded by hand on a glass plate using a spatula with boiled linseed oil. The linseed oil is added drop-wise from a burette and the amount required to achieve the end point is measured. The end point is determined as the point at which the 5 g of material is completely saturated with oil and has a consistency of putty. The volume of oil required to achieve the end point is converted to weight of oil per weight of material (ie. g/100 g).

### EXAMPLES AND ILLUSTRATIVE EMBODIMENT

### Example 1

### Production of zeolite N with KOH and KCl

75 kg of 98% solid potassium hydroxide (Redox Chemicals, caustic potash Capota45, QLD Australia), 75 kg of 98% solid potassium chloride (Redox Chemicals, POCHLO16, QLD Australia) and 250 litres of water supplied by a conventional domestic reticulated system are placed in a 500 L stainless steel reactor tank. This caustic solution is stirred and heated to 95° C. While the solution is at this temperature, 75 kg of kaolin (Kingwhite 65, supplied by Unimin Pty Ltd, Kingaroy, QLD Australia) is added to the reaction mix while stirring the solution. The reaction mix experiences a slight drop in temperature (to ˜90° C.) during the loading of kaolin. Depending on the quality of heating process employed, the reaction mixture may show temperature fluctuations of up to 5° C. without significant loss of product quality. Small quantities of solid materials (approximately 50 g) from the reaction mix are sampled at half-hourly intervals during this reaction and are characterised by conventional methods.

The reaction tank is partially covered with a stainless steel lid to aid with retention of heat and vapour(s). The reaction tank is maintained at ambient pressure during the production process. The pH of this reaction mix is generally greater than 14.0 and during the course of the reaction may reduce to approximately 13.5. During the reaction process—approximately 1.5 hours to 3.5 hours after the kaolin has been added to the reactor—the viscosity of the mixture increases. Addition of small amounts of water at this time to aid mixing of the slurry may be undertaken though it is not necessary to achieve production of zeolite N.

After 6.0 hours of reactant mixing at temperatures 95° C.±5° C., the reaction is stopped by reduction of the temperature to less than 50° C. via cooling coils, addition of water or both methods and the resulting slurry is separated using a filter press into solid and liquid components. The solid aluminosilicate—zeolite N—is washed with water and then dried using conventional drying methods (such as a spray dryer) to form the final product with properties listed in Table 6. The weight of zeolite N from this reaction is 98.3 kg which represents a volume yield of greater than 90% for the reaction.

Characterisation of the material using standard methods such as X-ray diffraction, bulk chemical analysis, surface area analysis and cation exchange capacity will be known to those skilled in the art.

### Example 2

### Recycle of Mixed Caustic Liquor from Example 1 Reaction

120 kg of the liquor containing both KOH and KCl and any un-reacted kaolin from the process described in Example 1 is retained for transfer back to the reaction tank. The reaction tank is topped up with 254 kg of caustic (comprising 59.1 kg of KOH, 54.2 kg of KCl and 141.4 L of water) and pre-heated to 95° C. 75 kg of kaolin is added to the caustic liquor, mixed thoroughly for 6.0 hours while maintaining the reaction temperature at 95° C.±5° C. After 6.0 hours, the reaction tank is cooled to less than 50° C. and the resulting slurry is separated into solid and liquid components using a filter press. The solid is washed with water and then dried using conventional drying methods (such as a spray dryer) to form the final product with properties listed in Table 6.

The same procedure given above is repeated for the next seven reactions using appropriate masses of caustic recycle and caustic make-up for each run. The properties of the resultant zeolite N from selected batch reactions using recycled liquor are listed in Table 6. FIG. 8 shows cation exchange capacities determined for each zeolite N batch produced by the recycling of caustic liquor and the evolution of CEC values as each reaction proceeds to completion.

### Example 3

### Variation of Process for zeolite N Production—Time and Method of Reaction

75 kg of 98% solid potassium hydroxide, 75 kg of 98% solid potassium chloride, 250 litres of water supplied by a conventional domestic reticulated system and 75 kg of kaolin are placed in a 500 L stainless steel reactor tank. This reaction mix or viscous slurry is stirred and heated to 95° C. over a period of seven hours. Once the slurry is at 95° C., the reaction is maintained at 95° C.±3° C. for a further nine hours and then cooled to less than 50° C. to stop the reaction. The resulting slurry is separated using a filter press into solid and liquid components. The solid aluminosilicate—zeolite N—is washed with water and then dried using conventional drying methods (such as a spray dryer) to form the final product with properties listed in Table 6.

### Example 4

### Variation of Process for zeolite N Production—KOH with Other chloride Salt

75 kg of 98% solid potassium hydroxide, 30 kg of 98% solid sodium chloride (Cheetham Salt, Superfine grade, Australia), and 180 litres of water supplied by a conventional domestic reticulated system are placed in a 500 L stainless steel reactor tank. This caustic solution is stirred and heated to 95° C. While the solution is at this temperature, 60 kg of kaolin is added to the reaction mix while stirring the solution.

After 6 hours of mixing at temperatures 95° C.±5° C., the reaction is stopped by reduction of the temperature to less than 50° C. via cooling coils, addition of water or both methods and the resulting slurry is separated using a filter press into solid and liquid components. The solid aluminosilicate—zeolite N—is washed with water and then dried using conventional drying methods (such as a spray dryer) to form the final product with properties listed in Table 6.

### Example 5

### Variation on zeolite N Process—KOH with Two chloride Salts

600 g of 98% solid potassium hydroxide, 1,500 g of solid potassium chloride, 350g of 98% solid sodium chloride, and 2.21 litres of water supplied by a conventional domestic reticulated system are placed in a 5 L stainless steel reactor tank. This caustic solution is stirred and heated to 95° C. While the solution is at this temperature, 550 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6.

### Example 6

### Formation of zeolite N with potassium hydroxide, sodium hydroxide and chloride Salts

488 g of 98% solid potassium hydroxide, 373 g of solid potassium chloride, 100 g of solid sodium hydroxide (Redox Chemicals, QLD Australia), 125 g of 98% solid sodium chloride, and 2.21 litres of water supplied by a conventional domestic reticulated system are placed in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6.

### Example 7

### Formation of zeolite N using Liquid potassium silicate and Other Salts

660 g of 98% solid potassium hydroxide, 660 g of 98% solid potassium chloride, 150 g of liquid potassium silicate (Kasil 30, supplied by PQ Corporation, Melbourne Australia) and 2.21 L of water supplied by a conventional domestic reticulated system are placed in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6. The powder X-ray diffraction pattern for this example is shown in FIG. 2.

### Example 8

### Formation of zeolite N Using potassium silicate and zeolite N Seed

660 g of 98% solid potassium hydroxide, 660 g of 98% solid potassium chloride, 450 g of liquid potassium silicate (Kasil 30, supplied by PQ Corporation, Melbourne Australia), 2.21 L of water supplied by a conventional domestic reticulated system and 180 g of zeolite N formed by the process in Example 1 are placed in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6. Indexed reflections for X-ray powder diffraction of this sample are listed In Table 4. Note that this form of zeolite N has a Si:Al ratio higher than material formed in Examples 1, 2 and 4.

### Example 9

### Formation of zeolite N using a 2:1 Clay

1,150 g of 98% solid potassium hydroxide, 850 g of 98% solid potassium chloride and 1.6 L of water supplied by a conventional domestic reticulated system are placed in a 5 L stainless steel reactor tank. This caustic solution is stirred and heated to 95° C. While the solution is at this temperature, 660 g of montmorillonite (Activebond 23, supplied by Unimin Pty Ltd, Australia) are added to the reaction mix while stirring the solution.

The reaction is undertaken substantially as described in Example 1 for a period of 10 hours at 95° C. The solid aluminosilicate—zeolite N—is washed with water and then dried using conventional drying methods (such as a spray dryer) to form the final product with properties listed in Table 6. The powder X-ray diffraction pattern for this example is shown in FIG. 5. Note that this form of zeolite N has a Si:Al ratio higher than that material formed from kaolin (see Examples, 1, 2 and 4) and a resultant lower CEC value determined using standard procedures.

### Example 10

### Formation of zeolite N without chloride ion

1,650 g of 98% solid potassium hydroxide and 0.9 L of water supplied by a conventional domestic reticulated system are placed in a 5 L stainless steel reactor tank. This caustic solution is stirred and heated to 90° C. While the solution is at this temperature, 330 g of kaolin are added to the reaction mix while stirring the solution.

The reaction is undertaken substantially as described in Example 1 for a period of 12 hours at 90° C. The solid aluminosilicate—zeolite N—is washed with water and then dried using conventional drying methods (such as a spray dryer) to form the final product with properties listed in Table 6. An X-ray diffraction pattern for this zeolite N product is shown in FIG. 6. indexed reflections for this product are provided in Table 4.

### Example 11

### Formation of zeolite N using ammonium salt and caustic

660 g of 97% ammonium chloride (Redox Chemicals, QLD Australia) is added to 1.93 L of water in a 5 L stainless steel reactor tank. A further 1,200 g of 98% solid potassium hydroxide is slowly added to this mixture. The caustic solution is stirred and heated to 95° C. While the solution is at this temperature, 600 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6. Indexed reflections for X-ray powder diffraction of this sample are listed in Table 4.

### Example 12

### Formation of Zeolite N at Lower Temperature and Higher Water Content

1,880 g of 98% solid potassium hydroxide, 1,310 g of 98% solid potassium chloride, 3.0 litres of water supplied by a conventional domestic reticulated system and 375 g of kaolin are placed in a 5 L stainless steel reactor tank. This reaction mix or viscous slurry is stirred and heated to 80° C. over a period of twelve hours and then cooled to less than 50° C. to stop the reaction. The resulting slurry is separated using a filter into solid and liquid components. The solid aluminosilicate—zeolite N—is washed with water and then dried using conventional drying methods (such as a spray dryer) to form the final product with properties listed in Table 6.

### Example 13

### Formation of Zeolite N with KOH and a Sodic Salt

660 g of 98% solid potassium hydroxide, 150 g of 98% solid sodium chloride and 2.21 L of water are placed in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate—zeolite N—is washed with water and then dried using conventional drying methods (such as a spray dryer) to form the final product with properties listed in Table 6.

### Example 14

### Comparative Synthesis with Insufficient Potassium or Chloride

120 g of 98% solid potassium hydroxide, 400 g of 98% solid potassium chloride, 350 g of solid sodium hydroxide and 2.21 litres of water are placed in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate is washed with water and then dried using conventional drying methods (such as a spray dryer) and characterised using standard methods such as X-ray diffraction, bulk chemical analysis, surface area analysis and cation exchange capacity. X-ray diffraction of this sample shows that the zeolite N phase does not form. The X-ray data show that the crystalline phase is sodalite with minor amounts of amorphous aluminosilicate material.

### Example 15

### Comparative Synthesis using Christensen and Fjellv\dot{a}g (1997) Reactant Ratios

The reagents used by Christensen and Fjellv\dot{a}g (1997) are combined in the same ratios and subjected to process conditions described in this patent application. 660 g of 98% solid potassium chloride is combined with 2.6 L of water and placed in a 500 L stainless steel reactor tank. This solution is stirred and heated to 95° C. While the solution is at this temperature, 264 g of zeolite 4A (supplied by PQ Corporation, VIC Australia) are added to the reaction mix while stirring the solution.

The reaction is undertaken substantially as described in Example 1 for a period of 6 hours at 95° C. The solid aluminosilicate is washed with water and then dried using conventional drying methods (such as a spray dryer) and characterised using standard methods such as X-ray diffraction and cation exchange capacity. X-ray diffraction of this sample shows that the zeolite N phase does not form. The X-ray data show that the crystalline phase is zeolite 4A.

### Example 16

### Comparative Synthesis using Christensen and Fjellv\dot{a}g (1997) Reactant Ratios and Lower Water Content

The reagents—zeolite 4A and potassium chloride—used by Christensen and Fjellv\dot{a}g (1997) are combined in the same ratios and subjected to process conditions described in this patent application at the same ratio of H₂O/Al₂O₃ as used in Example 1. 660 g of 98% solid potassium chloride is combined with 0.6 L of water and placed in a 500 L stainless steel reactor tank. This solution is stirred and heated to 95° C. While the solution is at this temperature, 264 g of zeolite 4A (supplied by PQ Corporation, VIC Australia) are added to the reaction mix while stirring the solution.

The reaction is undertaken substantially as described in Example 1 for a period of 6 hours at 95° C. The solid aluminosilicate is washed with water and then dried using conventional drying methods (such as a spray dryer) and characterised using standard methods such as X-ray diffraction and cation exchange capacity. X-ray diffraction of this sample shows that the zeolite N phase does not form. The X-ray data show that the crystalline phase is zeolite 4A.

### Example 17

### Comparative Synthesis without Chloride Ion at Higher Temperature

1,650 g of 98% solid potassium hydroxide and 0.9 L of water supplied by a conventional domestic reticulated system are placed in a 5 L stainless steel reactor tank. This caustic solution is stirred and heated to 95° C. While the solution is at this temperature, 330 g of kaolin are added to the reaction mix while stirring the solution. The ratio of reactants in the starting mixture is the same as described in Example 10.

The reaction is undertaken substantially as described in Example 1 for a period of 24 hours at 95° C. Sampling of the reaction mix at 6 hours and 12 hours indicated the formation of kaliophyllite only. The solid aluminosilicate is washed with water and then dried using conventional drying methods (such as a spray dryer) and characterised using standard methods such as X-ray diffraction and cation exchange capacity. X-ray diffraction of this sample shows that zeolite N does not form. The X-ray data show that the crystalline phase is kaliophyllite.

### Example 18

### Comparative Synthesis with Insufficient Chloride from Two Salts

660 g of 98% solid potassium hydroxide, 100 g of solid potassium chloride and 75 g of solid sodium chloride is placed with 2.21 L of water in a 5 L stainless steel reactor tank. This caustic solution is stirred and heated to 95° C. While the solution is at this temperature, 660 g of kaolin are added to the reaction mix while stirring the solution.

The reaction is undertaken substantially as described in Example 1 for a period of 6 hours at 95° C. The solid aluminosilicate is washed with water and then dried using conventional drying methods (such as a spray dryer) and characterised using standard methods such as X-ray diffraction and cation exchange capacity.

An X-ray diffraction pattern of this sample (FIG. 3) shows that zeolite N does not form. The X-ray data show that the resultant material is kaolin amorphous derivative as previously described in U.S. Pat. No. 6,218,329 B1, U.S. Pat. No. 6,218,329 B2 and U.S. Pat. No. 5,858,081.

### Example 19

### Exchange of Potassium Zeolite N to Sodium Zeolite N Form

20 kg of zeolite N formed by the process described in Example 1 are placed in a stainless steel reaction tank and thoroughly mixed with 2M NaOH solution for two hours at room temperature (−25° C.). The solid and liquid are separated via conventional means (e.g. a filter press or by sedimentation/decanting). The solid is washed thoroughly in water and then dried by conventional means (e.g. spray dryer). The solid shows partial exchange of potassium ions for sodium ions and the properties listed in Table 6. X-ray powder diffraction confirms the sodium exchange form is zeolite N. Further exchange of potassium and sodium ions in zeolite N is effected by additional exchanges of the type described in this example.

### Example 20

### Exchange of Potassium Zeolite N to Ammonium Zeolite N

20 kg of zeolite N formed by the process described in Example 3 are placed in a stainless steel reaction tank and thoroughly mixed with 5M NH₄NO₃ solution held at 70° C. for two hours. The solid and liquid are separated via conventional means (e.g. a filter press or by sedimentation/decanting), the solid is washed thoroughly in water and then subjected to a second exchange using 5M NH₄NO₃ solution held at 70° C. for two hours. The solid is washed thoroughly in water and dried by conventional means (e.g. spray dryer). The solid shows exchange of potassium ions for ammonium ions and the properties listed in Table 6. X-ray diffraction shows the phase has zeolite N structure. Almost complete exchange of potassium ion is demonstrated by the bulk analysis (K₂O=2.0 wt %) and high value for loss-on-ignition determination (LOI=23.4 wt %).

### Example 21

### Comparative Cation Exchange Capacities for Ammonium Ions on a Mass and Volume Basis

Zeolite 4A (PQ Corporation), Clinoptilolite (Australian Zeolites), montmorillonite (Activebond 23) and kaolinite (Kingwhite 65; Unimin Australia Pty Ltd) are compared with zeolite N prepared by methods as disclosed in Examples 1.

Cation exchange capacities are determined experimentally for equilibrium exchange of ammonium ion as described in the Standard Procedures. Table 7 shows that the highest ammonium ion CEC value, by mass or volume, is for zeolite N described in this invention. Zeolite A also exhibits good capacity for ammonium ions in accord with a low Si/Al ratio. However, as shown below zeolite A does not satisfy commercial criteria such as ammonium ion selectivity.

### Example 22

### Selectivity of Zeolite N for Ammonium Ions in the Presence of Alkaline Earth or Alkali Metal Ions Compared to Zeolite A and Clinoptilolite

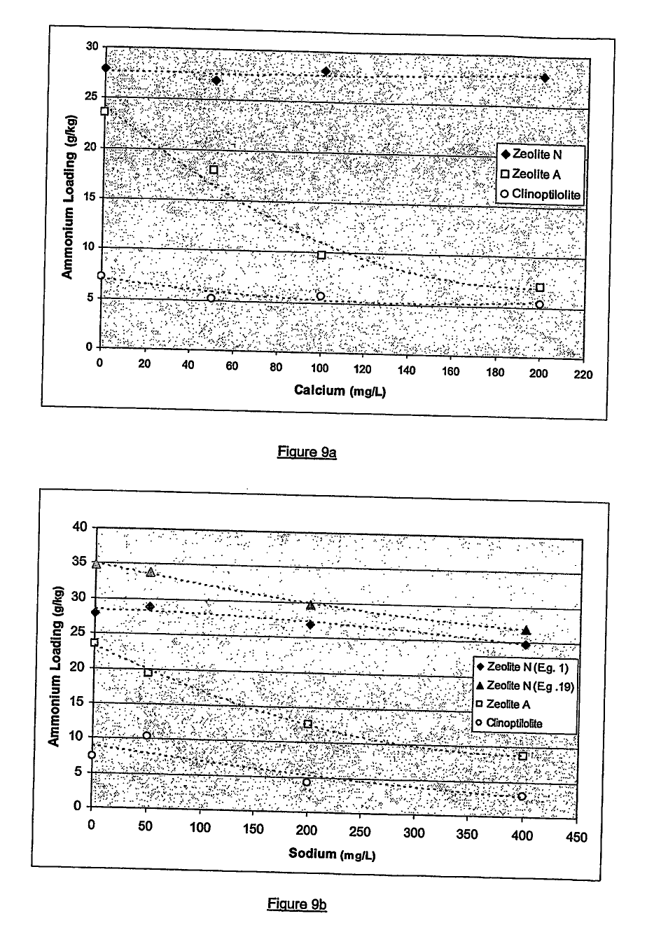

Zeolite N, zeolite A and clinoptilolite are compared in this example. Amounts of 0.2 g of zeolite material are placed in 200 mL of aqueous solutions of ammonium ions (prepared from ammonium chloride) and constantly agitated for a period of 2 hours at ambient temperature. To evaluate the selectivity of zeolites N, A and clinoptilolite in the presence of alkaline ions, different amounts of calcium ions (prepared from calcium chloride precursor) are added to the ammonium ion solution. FIG. 9a shows the effect of calcium ion concentration upon the ammonium loading of zeolites N, A and Clinoptilolite when a constant ammonium ion concentration of 50 mg/L is present in the solution.

The capacity for ammonium ion uptake by zeolite N is not significantly influenced by concentrations of competing calcium ions up to 200 mg/L. In contrast, the capacity for ammonium ion uptake by zeolite A in the presence of competing calcium ions is significantly reduced. For example, the loading of ammonium ions changes from 23.5 g/kg when no calcium ions are present to 7.1 g/kg when 200 mg/L calcium ions are present. The ammonium loading for zeolite A in the presence of high calcium concentration is similar to that for clinoptilolite. Clinoptilolite shows low capacity for ammonium ions under all testing conditions.

To evaluate the selectivity of zeolites N, A and clinoptilolite in the presence of alkali metal ions, different amounts of sodium ions are added to the ammonium ion solution. FIG. 9b shows the effect of sodium ion concentration upon the ammonium loading of zeolites N, A and Clinoptilolite when a constant ammonium ion concentration of 50 mg/L is present in the solution.

The capacity for ammonium ion uptake by zeolite N is not significantly influenced by concentrations of competing sodium ions up to 400 mg/L. Surprisingly, the capacity for ammonium ion uptake by zeolite A in the presence of competing sodium ions is significantly reduced. For example, the loading of ammonium ions changes from 23.5 g/kg when no sodium ions are present to 8.7 g/kg when 400 mg/L sodium ions are present. Clinoptilolite shows low capacity for ammonium ions under all testing conditions.

### Example 23

### Comparative Selectivity for Ammonium Ion in Aqueous Solutions with Ca²⁺ and Mg²⁺ Ions

Zeolite 4A (PQ Corporation) and clinoptilolite (Australian Zeolites) are compared with zeolite N prepared by methods disclosed in Examples 1 and 19. Approximately 0.2 g of zeolite material is equilibrated at room temperature for 1 hour with 200 mL of an aqueous solution comprising ammonium, calcium and magnesium ions at the concentrations indicated in Table 8. The comparative results determined as equivalent cation exchange capacities for each zeolite in each solution are tabulated in Table 9.

Table 9 shows that both forms of zeolite N are characterized by a high loading capacity for ammonium ions in the presence of calcium and magnesium ions. In contrast, zeolite A is not selective towards ammonium ions in the presence of calcium and magnesium ions. Furthermore, the data for clinoptilolite shows that calcium and magnesium ion concentration actually increases when this material is added to the test solution. The CEC value for clinoptilolite for ammonium ions is considerably lower than the value recorded for zeolite N.

For solutions containing 1,000 mg/L ammonium ions, the loading values for ammonium ion are 444 meq/100 g and 451 meq/100 g for zeolite N (Examples 1 and 19), respectively, when 50 mg/L calcium ions are present and 475 meq/100 g and 434 meq/100 g for zeolite N, respectively, when 120 mg/L calcium ions are present. Consequently, zeolite N is an excellent material for ammonium ion exchange capacity and ammonium ion selectivity for a wide range of ammonium and alkaline earth ion concentrations.

In contrast, the performance of zeolite 4A is detrimentally affected by the presence of additional calcium ions in solution. For solutions containing 1,000 mg/L ammonium ions, the loading value for zeolite 4A is 261 meq/100 g when 50 mg/L calcium ions are present and 192 meq/100 g when 120 mg/L calcium ions are present. This represents a drop of over 25% in the performance of zeolite 4A in the presence of competing Ca and Mg ions.

Clinoptilolite did not show any appreciable exchange for ammonium in the presence of calcium and magnesium ions with an increased concentration of calcium ions to 120 mg/L. However, the loading value for ammonium ions is low under all conditions (over 4 times lower than for zeolite N). Clinoptilolite does not offer properties suited to commercial treatment of wastewaters for removal of ammonium ions in the presence of Ca⁺² and Mg⁺².

### Example 24

### Regeneration of Ammonium-Loaded Zeolite N

A series of caustic solutions have been compared for regeneration of an ammonium-loaded zeolite N. The regenerant solution compositions include industrial grade NaOH (only), NaOH and NaCl, NaOH and Na₂CO₃ in a range of concentrations. Ammonium loading of zeolite N on each cycle is with 1M NH₄Cl solution.

For regeneration cycles, 20 g of ammonium loaded zeolite N is contacted with 80 ml of regenerant solution in a 250 mL Nalgene bottle with constant shaking for two hours. The solution is centrifuged at 3,000 rpm for five minutes and the amount of ammonium and pH of the supernatant is measured. For second and subsequent regenerations, the same procedure is used on re-loaded ammonium zeolite N. The removal rate of ammonium ion for each regenerant solution is determined by measurement of ammonium in the regenerant solution and on the solid sample before regeneration.

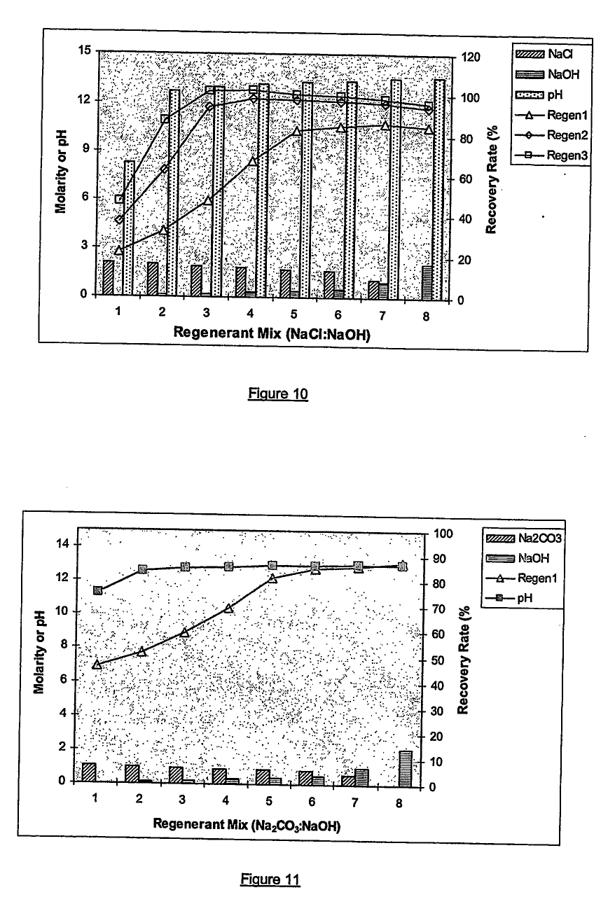

FIGS. 10 and 11 show the effective ammonium removal rate as a percentage of total ammonium on the material for solutions with different ratios of NaOH+NaCl and NaOH+Na₂CO₃. The data in FIGS. 10 and 11 show that for both combinations of solutions as a regenerant, removal of ammonium can be achieved at all ratios of NaCl or Na₂CO₃ to NaOH. This outcome is consistent with teachings from prior art.

However, for zeolite N of the present invention, a higher removal rate (i.e. >75%) for ammonium ion occurs for ratios in which NaOH is present at concentrations equivalent to or more than 0.4M. Furthermore, these data show that the highest removal rate occurs for NaOH only solutions. Thus, ammonium-loaded zeolite N is suited to regeneration by NaOH solutions held at high pH (i.e. greater than 12) without degradation of the material.

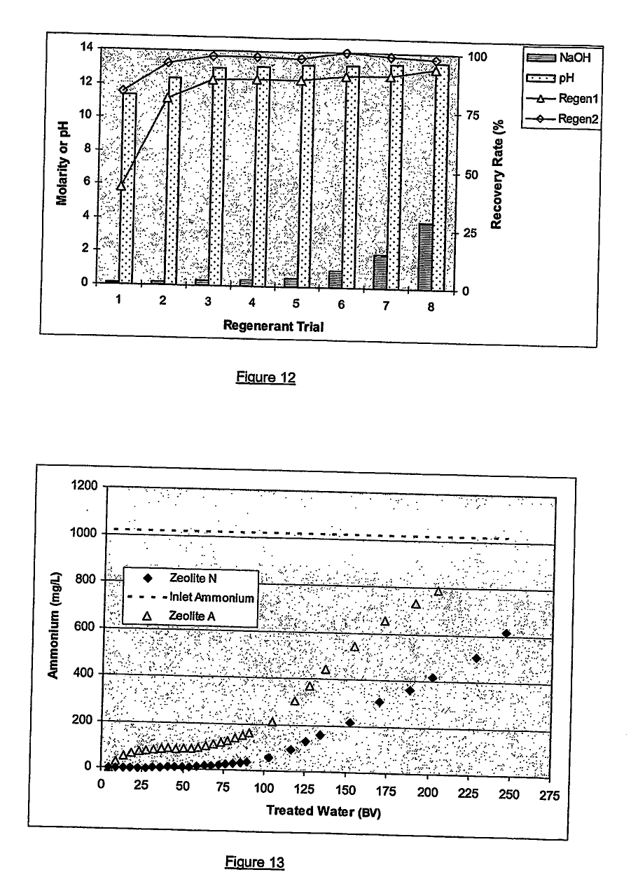

The range of NaOH concentrations for which an effective removal rate can be achieved from ammonium-loaded zeolite N is shown in FIG. 12. At low molarity (0.1M), the removal rate is low at 40%. However, at higher molarity and, specifically above 0.4M NaOH, the removal rate is greater than 85% for the first regeneration and higher for the second regeneration. In this instance, the form of zeolite N is potassic for the first cycle of loading/regeneration and sodic for the second cycle of loading/regeneration. For subsequent regenerations, removal rates of >90% are maintained when the molarity is >0.4M.

This comparison of regeneration solutions shows that ammonium-loaded zeolite N is ideally suited to regeneration by sodium-rich solutions and, in particular, by NaOH solutions with molarity greater than 0.4. This result is in contrast to that of Breck (U.S. Pat. No. 3,723,308) who showed that a saturated lime solution with sodium chloride and calcium chloride is a suitable regeneration solution for zeolite F and Sherman and Ross (U.S. Pat. No. 4,344,851) who used 1.0N NaCl with NaOH (adjusted to pH 12.0) to regenerate zeolites W and F. The data in FIG. 10 show that for NaCl/NaOH solutions with pH˜12.0 at high NaCl molarity, the ammonium removal rate is significantly less than a NaOH only solution (i.e. 32% vs 84% on first cycle; 62% vs 94% on second cycle).

### Example 25

### Comparative Example of Ammonium Exchange by Zeolite N and Zeolite A in a Fixed Bed Column

Granules of test material(s) are loaded into glass columns (φ˜52 mm; packed bed height ˜750 mm) with inlet and outlet openings suited to flow of test solutions and analysis of samples. The configuration of column arrangements for fixed bed treatment and the determination of bed volume for each material type are known to those skilled in the art. A synthetic solution (pH=7.25) containing 1,020 mg/L NH₄⁺ is introduced to the columns via variable speed pumps at flow rates ranging from 1.2 l/hr to 10.5 l/hr. The solutions are pumped in a down-flow direction for ammonia loading and in an upflow direction during regeneration. Use of regenerant solution(s) for ammonium-loaded zeolite N is described in Example 24.

The concentration of ammonium ion in the outflow after pumping through the column and the volume of solution treated is measured. Test solutions are pumped at a constant bed volume flow of 4.5 bed volumes per hour or 2.25 bed volumes per hour for each test sample. In each case, a similar mass of zeolite material is used in each column.

Comparative data for ammonium exchange of zeolite N (as described in Example 1) and zeolite A are shown in FIGS. 13 and 14 for the two different flow rates. In both cases, the “breakthrough” point—for this experiment taken as 50 mg/L ammonium concentration in the treated water—is achieved after a much longer period of time (or volume of water treated) by zeolite N than by zeolite A. For example, in FIG. 13 breakthrough is achieved by zeolite A after 12 bed volumes while zeolite N achieves breakthrough after 100 bed volumes. Data in FIG. 14 show that zeolite A achieves breakthrough in 14 bed volumes while zeolite N has not reached breakthrough after 120 bed volumes. Those skilled in the art will recognise that the performance of zeolite N under these conditions is superior to that of zeolite A.

### Example 26

### Comparative Ammonium Exchange by Zeolite N and Clinoptilolite in a Fixed Bed Column

Granules of test material(s) are loaded into glass columns (φ˜52 mm; packed bed height ˜750 mm) with inlet and outlet openings suited to flow of test solutions and analysis of samples as noted in Example 25. A synthetic solution (pH=7.6) containing 30 mg/L NH₄⁺ is introduced to the columns and the concentration of ammonium ion in the outflow after pumping through the column and the volume of solution treated is measured. Test solutions are pumped at a constant flow of 28 bed volumes per hour for each test sample. In each case, a similar mass of zeolite material is used in each column. For this test, clinoptilolite is pre-treated by the methods described in Komarowski and Yu (1997) to optimise ammonium loading capacity.

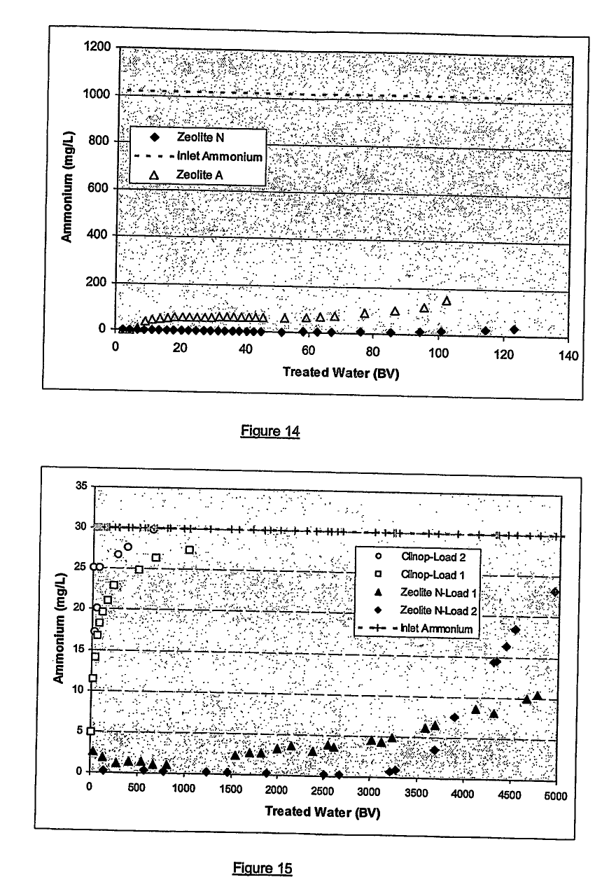

Comparative data for ammonium exchange of zeolite N (as described in Example 1) and clinoptilolite are shown in FIG. 15. Two cycles of loading are represented for each zeolite tested. Each zeolite is regenerated after the first loading using 1.2M NaOH solution as described in Example 24.

The “breakthrough” point for this experiment is 5 mg/L ammonium concentration in the treated water. Clinoptilolite shows capacity to remove ammonium from the synthetic solution for approximately 5 bed volumes in the first loading cycle, but does not achieve ammonium levels below 5 mg/L in the treated solution on the second loading cycle.

In contrast, zeolite N of the present invention reduces ammonium levels to well-below breakthrough for at least 3,000 bed volumes in the first loading cycle and for more than 3,750 bed volumes in the second loading cycle after regeneration.

Loading capacity for each zeolite can be determined by simple measurement of ammonium in the regenerant solution or by integration of ammonium concentration for a full loading cycle (i.e. to a point where outlet ammonium concentration is <5% the value of the inlet concentration). Using these methods, the loading capacity for clinoptilolite in this example is 2.3 g NH₄⁺ per kg of zeolite. This value is consistent with data previously obtained by Komarowski and Yu (1997) for clinoptilolite. For zeolite N, the loading capacity is 65 g NH₄⁺ per kg of zeolite.

### Example 27

### Comparative Ammonium Exchange by Zeolite N and Clinoptilolite in Wastewater Solution Containing Multiple Divalent and Univalent Ions

Granules of test material(s) are loaded into glass columns (φ˜52 mm; packed bed height ˜750 mm) with inlet and outlet openings suited to flow of test solutions and analysis of samples as noted in Example 25. Wastewater at pH 8.0 produced by an anaerobic digester side stream in a sewage treatment plant is introduced into the columns after a sand filtration step to remove suspended solids. Solutions are pumped at a constant flow rate of 2 bed volumes per hour for each test material. The mass of test material in all columns is equivalent for zeolite N and clinoptilolite. The digester side stream wastewater shows typical concentrations for Ca²⁺ and Mg²⁺ (43 mg/L and 13 mg/L, respectively), Na⁺ and K⁺ (320 mg/L and 230 mg/L, respectively) as well as high levels of alkalinity, BOD, COD and total dissolved solids (4,500 mg/L, 94 mg/L, 1,300 mg/L and 2,100 mg/L, respectively). The inlet ammonium ion concentration is 1,528 mg/L.

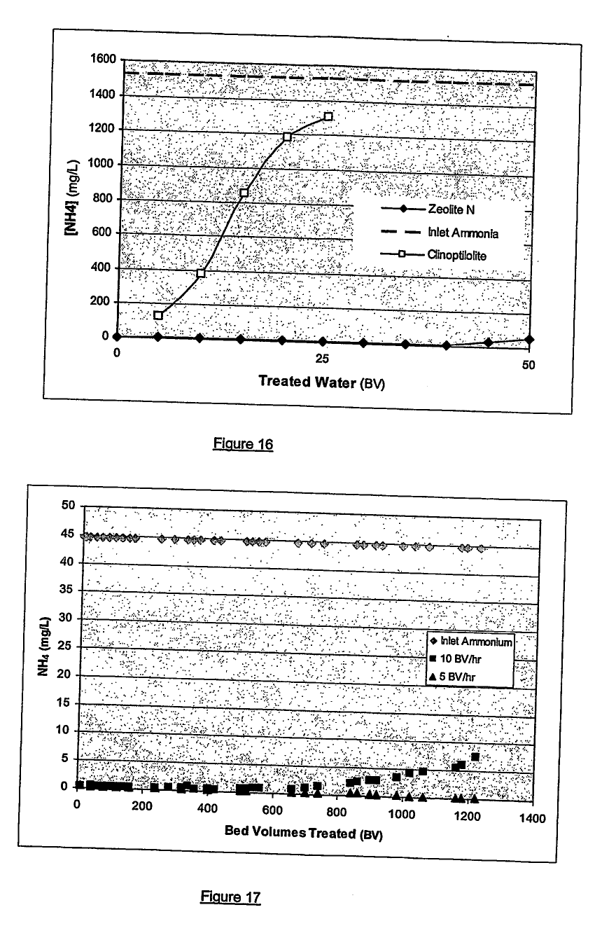

Comparative data for ammonium exchange using zeolite N (as described in Example 1) and clinoptilolite are shown in FIG. 16. For these experiments, a breakthrough point of 35 mg/L ammonium ion is achieved by zeolite N after more than 50 bed volumes are treated. In comparison, the same mass of clinoptilolite does not achieve an outflow concentration less than 35 mg/L under the same operating conditions. Clinoptilolite only reduces the outflow ammonium ion concentration to ˜130 mg/L in the first loading cycle shown in FIG. 16.

The poor performance of clinoptilolite in this instance is not only due to a low cation exchange capacity, but also due to poor selectivity for ammonium ions in the presence of Ca²⁺, Mg²⁺, Na⁺ and K⁺. However, zeolite N clearly removes ammonium ion from digester side stream which contains competing ions such as Ca²⁺, Mg²⁺, Na⁺ and K⁺ and trace levels of transition metals (e.g. CU²⁺, Zn²⁺ and Fe²⁺).

### Example 28

### Ammonium Ion Removal from Primary Flow at a Sewage Treatment Plant

Granules of test material are loaded into glass columns (φ˜52 mm; packed bed height ˜750 mm) with inlet and outlet openings suited to flow of test solutions and analysis of samples as noted in Example 25. Wastewater at pH˜7.0 collected from the exit of a primary clarifier in a large sewage treatment plant is introduced into the columns without a pre-filtration step to remove suspended solids. Solutions are pumped at constant flow rates of 5 bed volumes per hour and 10 bed volumes per hour. The wastewater shows a typical primary treated sewage composition for Ca²⁺ and Mg²⁺ (30 mg/L and 22 mg/L, respectively), Na⁺ and K⁺ (160 mg/L and 18 mg/L, respectively) as well as typical levels of alkalinity, BOD, COD, suspended solids and total dissolved solids (560 mg/L, 87 mg/L, 100 mg/L, 54 mg/L and 628 mg/L, respectively). The inlet ammonium ion concentration is 44 mg/L.

Data on the removal of ammonium ion using these exchange columns at two flow rates are shown in FIG. 17. FIG. 17 shows that for a breakthrough point of 1 mg/L ammonium ions, zeolite N is an excellent medium for removal of ammonium at high flow rates. At 10 BV/hr (equivalent to a hydraulic residence time of 6 minutes), zeolite N reduces outflow ammonium concentrations to less than 1 mg/L for more than 650 bed volumes. At lower flow rates (e.g. 5 BV/h), ammonium ion concentrations in the treated water remain well below breakthrough after 1,200 bed volumes. Those skilled in the art will recognise that improved performance of zeolite N for ammonium ion removal will be achieved with pre-filtration of the inlet column flow.

### Example 29

### Ammonium Ion Removal from Landfill Leachate by Zeolite N

Granules of test material are loaded into glass columns (φ˜52 mm; packed bed height ˜750 mm) with inlet and outlet openings suited to flow of test solutions and analysis of samples as noted in Example 25. Wastewater at pH˜8.2 collected from a landfill is introduced into the columns without a pre-filtration step to remove suspended solids. The leachate is pumped at a constant flow rate of 4 bed volumes per hour. The leachate shows concentrations typical for a mature landfill with Ca²⁺ and Mg²⁺ (62 mg/L and 38 mg/L, respectively), Na⁺ and K⁺ (1,100 mg/L and 340 mg/L, respectively) as well as typical levels of alkalinity, suspended solids and total dissolved solids (2,200 mg/L, 18 mg/L and 3,700 mg/L, respectively). The inlet ammonium ion concentration is 205 mg/L.

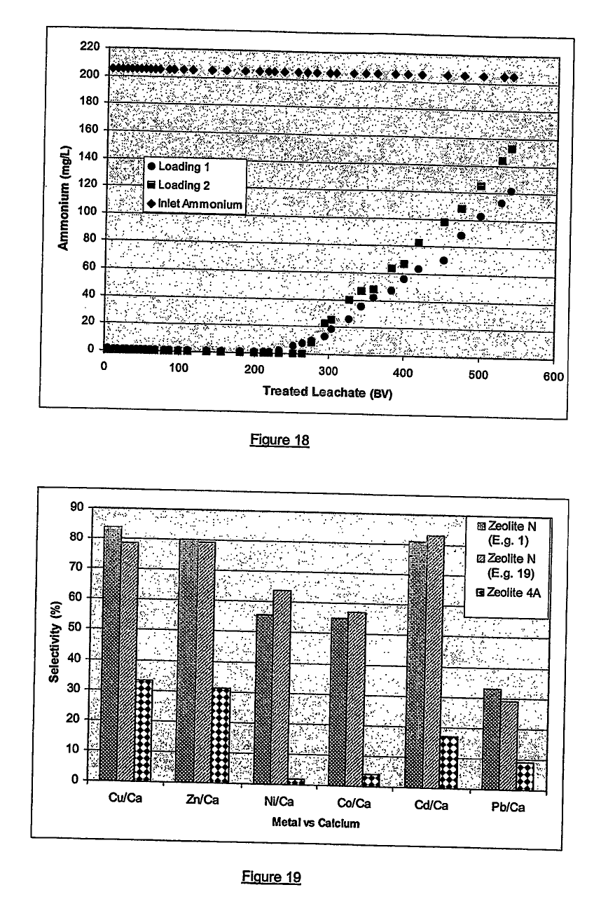

Data for two successive loadings of ammonium onto the pre-treated zeolite N fixed bed columns are shown in FIG. 18. Regeneration of the ammonium-loaded zeolite N using 1.2M NaOH solution only follows the methods outlined in Example 24. For this wastewater, the concentration of sodium and potassium ions is many times the concentration of ammonium Ions (a factor of ˜6 times). However, data in FIG. 18 show clearly that ammonium ion concentration is reduced to less than 1 mg/L in the treated outflow for many bed volumes (e.g. greater than 230 bed volumes at 4 BV/h). Furthermore, the ammonium loading capacity after regeneration of zeolite N granules is equivalent to, or better than, the ammonium loading capacity on the first cycle.

### Example 30

### Use of Zeolite N for Ammonium Ion Removal from an Aqueous Solution in the Presence of Calcium, Potassium and Sodium Ions at Typical Levels for Ruminal Fluid

Zeolite 4A and clinoptilolite are compared with zeolite N as described in Examples 1 and 19. An amount of 0.2 g of zeolite material is equilibrated at room temperature for 1 hour with 200 mL of an aqueous solution comprising 1,000 mg/L ammonium, 100 mg/L calcium, 2,000 mg/L potassium and 2,000 mg/L sodium ions. Results on treatment of this solution with zeolite A, zeolite N and clinoptilolite are shown in Table 10.

The data in Table 10 reveal that zeolite N is characterized by a high loading capacity for ammonium ions in the presence of calcium, sodium and potassium ions (a positive value for loading shows that ions are adsorbed by the material of interest, whereas a negative value shows that ions are released into the solution by the material of interest). In contrast, zeolite 4A, with a theoretical high loading for ammonium ions, was found to be non-selective towards ammonium ions in the presence of calcium, sodium and potassium ions. Furthermore, the data for clinoptilolite is unusual in that calcium and magnesium ion concentration actually increases when this material is added to the tested aqueous solution. For clinoptilolite, the CEC value for ammonium ions is considerably lower than the value recorded for zeolite N.

The percentage selectivity for ammonium, for example, is defined as:
% selectivity=(CEC_{NH4+}/CECₜₒₜ of zeolite)×100 (1)
where total CECₜₒₜ=CEC for calcium+CEC for ammonium+CEC for sodium (±CEC for potassium) and CECN_{NH4+·}=CEC for ammonium ion. The choice of sodium or potassium ions in equation (1) depends upon which of these ions is adsorbed by the material of interest. Table 10 also shows data for the excess ions in solution. This value is calculated from the measured concentrations of ions in solution after the material of interest has been added. The low value for excess ions in all cases Indicates that ion exchange (rather than precipitation of insoluble phases) occurs under these experimental conditions.

The values presented in Table 10 clearly show the higher selectivity of zeolite N for ammonium over alkali metal and alkaline earth ions compared to zeolite 4A and clinoptilolite. This selectivity is a critical property for commercial application for ammonia concentration control in ruminant animals.

### Example 31

### Use of Zeolite N as a Component of Pet Litter

The effectiveness of zeolite N for reduction of odours associated with ammonia from cat litter is evaluated at six professional veterinary practices. Approximately 10% of conventional cat litter is substituted with zeolite N granules and the modified litter is placed in animal cages following standard procedure at each veterinary practice. Subjective responses from staff regarding the degree of odour reduction are then compiled. In all cases, zeolite N is considered to successfully reduce ammonia odours. Animals—specifically cats—are not detrimentally affected by its use.

### Example 32

### Use of Zeolite N in Aquaria to Maintain Low Ammonium Concentrations

Zeolite N is applied to separate aquaria (fresh or saline water) for ten different fish species to reduce ammonium ion accumulation due to natural causes. The zeolite is presented in several different configurations: either located (i) in an air driven corner filter, (ii) in a nylon mesh bag in the filter, or (iii) in a floating nylon mesh bag. Each aquarium contained between 3 and 300 fish, depending on the species. For each aquarium, water ranged between pH 7.0 and 7.2. Zeolite N is held in the aquaria for periods ranging from 12 weeks to 48 weeks without detrimental impact on the fish. During this time, the ammonium levels in all aquaria remained below 0.2 mg/L.

### Example 33

### Comparative Exchange for Copper, Zinc, Nickel, Cobalt, Cadmium or Lead Ion from an Aqueous Solution in the Presence of Calcium Ions

Zeolite 4A (PQ Corporation) and clinoptilolite (Australian Zeolites) are compared with zeolite N as disclosed in Examples 1 (a potassium form) and 19 (sodium-potassium form). Approximately 0.2 g of zeolite material was equilibrated at room temperature for 1 hour with 200 mL of an aqueous solution comprising 50 mg/L of the appropriate metal ion (e.g. copper, zinc, nickel, cobalt, cadmium or lead) and 200 mg/L calcium ions. The relative cation loadings for each zeolite on each solution containing a metal ion with calcium ions are given in Table 11. Percentage selectivity for the specific metal ion is also summarised in Table 11.

Table 11 reveals that, for example, zeolite N is characterized by a high loading capacity for copper ions in the presence of calcium ions (a positive value for loading shows that ions are adsorbed by the material of interest, whereas a negative value shows that Ions are released into the solution by the material of interest). Similarly, zeolite 4A shows a comparable value for loading capacity for copper ions. Clinoptilolite is a very poor material for exchange of copper ions from aqueous solution.

However, the calcium ion uptake for each zeolite varies significantly. Zeolite 4A exchanges large quantities of calcium ions and clinoptilolite loads fewer calcium ions. For both zeolite A and clinoptilolite, the calcium ion uptake is approximately twice the amount of ammonium ion uptake. However, the performance of zeolite N which exhibits the lowest exchange of calcium ions in the presence of copper ions shows that the material has the highest selectivity for small-sized metal ions such as copper. Table 11 compares the copper selectivity values for zeolite N relative to zeolite 4A and clinoptilolite. The data in Table 11 show that zeolite N is highly selective towards copper ion in the presence of excess amounts of competing calcium ions in solution.

Similar data are obtained for the zinc/calcium, nickel/calcium, cobalt/calcium, cadmium/calcium and lead/calcium systems and are shown in Table 11. The values for cadmium loading onto zeolite N are lower than for copper ion loading, but again, the selectivity of zeolite N for cadmium ions over calcium ions is high (>80%) as shown in Table 11. These selectivity values for cadmium are significantly higher than the value for zeolite 4A. The selectivity value for clinoptilolite—whilst 100%—has little practical value as the loading capacity is extremely poor (<3 meq/100 g).

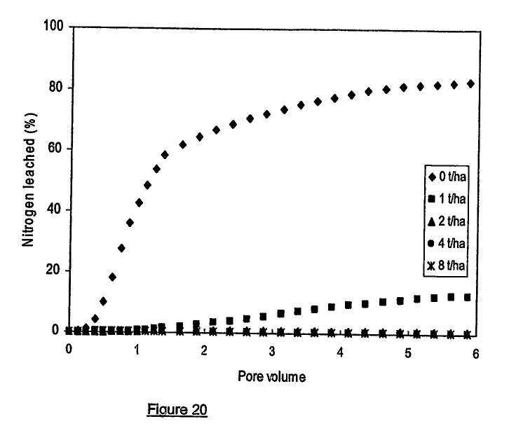

Table 11 lists data for nickel and shows that zeolite N of Example 1 is lower in loading capacity than zeolite N of Example 19 but both are significantly higher than zeolite 4A. The selectivity for nickel ions over calcium ions is significantly higher for zeolite N than for zeolite 4A or clinoptilolite. Similarly, the selectivity of zeolite N for cobalt and lead is higher that the selectivity determined for zeolite A or clinoptilolite. A summary of the selectivity data for these metal ions against calcium is shown in FIG. 19 for the zeolites used in this example.

Table 11 also shows the excess ions in solution for each metal/alkali ion system. This value is calculated from the measured concentrations of ions in solution after the material of interest has been added. The low value for excess ions in all cases indicates that ion exchange (rather than precipitation of insoluble phases) occurs under these experimental conditions. While not wishing to be bound by theory, similarly high selectivity for other metal ions such as silver over calcium ions is anticipated for zeolite N.

### Example 34

### Reduced Nitrogen Leaching with Zeolite N as a Soil Supplement

A sandy soil is thoroughly mixed with zeolite N (prepared as disclosed in Example 1) at the rate 0, 1, 2, 4 and 8 g/kg. The soil mixtures are packed into columns and treated with water obtained from a natural underground bore. The leading 20 ml of water treatment is fertilised with ammonium sulphate fertiliser at the rate of 25 mg N per kg of soil. A flow rate of 10 millilitres per min is maintained through the soil column. Samples of leachate are collected in 10 mL vials and analysed for ammonium and total nitrogen content. Data on analysed nitrogen in the leachate samples are plotted in FIG. 20 for pore volumes treated (i.e. equivalent to volume flow of bore water).

In FIG. 20, the control sample, in which no zeolite N is mixed with the soil column, demonstrates typical nitrogen leachate rates for sandy soils. For example, within one pore volume of solution treatment, more than 50% of the available nitrogen is leached from the column. However, with addition of zeolite N in the soil mixture, nitrogen leaching is reduced significantly. At one pore volume, less than 5% of the available nitrogen has leached from the column. At four pore volumes with the lowest zeolite N application rate, less than 10% of the nitrogen has leached from the column.

### Example 35

### Antimicrobial Activity of Zeolite N

Zeolite N prepared according to the method disclosed in Example 1 is co-exchanged with zinc, silver and ammonium ion. A co-exchanged version of zeolite A is also prepared for comparison with zeolite N. Zeolites co-exchanged with silver, zinc and ammonium ions are prepared as follows: 0.1 kg of zeolite is mixed with 375 mL of an aqueous solution comprising 0.05 M silver nitrate, 0.454 M zinc nitrate and 0.374 M ammonium nitrate salts. Following addition of water to make a total volume of 1000 mL of solution, the sample is stirred and heated at approximately 50° C. overnight. After filtering and drying at 110° C., the exchanged zeolite sample contained 2 wt % silver, 11 wt % Zn and 2.5 wt % ammonium.

A bacterial cell suspension of approximately 10⁶ cells is made up in 100 mL of sterile, distilled water in a sterile flask. 100 mg of antimicrobial zeolite powder is added to the test suspensions. The control sample is a 100 mL bacterial suspension of ca. 10⁶ cells without the presence of antimicrobial zeolite material. Three separate strains of bacteria are prepared for evaluation: ACM 1900 Escherichia coli, ACM 5201 Pseudomonas aeruginosa and ACM 1901 Staphylococcus aureus. E. coli and P. aeruginosa are common gram negative strains while S. aureus is gram positive.

The flasks are placed on a shaker at 150 rpm in an incubation room at 28° C. under light conditions. At contact times of 0, 4 and 24 h, 1 mL of culture are taken and serial dilution is performed. The dilutions are plated on spread plates of PYEA in order to determine the bacterial concentration. Viable counts of bacteria are performed after the plates are incubated at 37° C. overnight.

Results of the plate counts for each bacterial strain are listed in Table 12. Plate counts show that 100% of the three bacterial strains are destroyed at 4 hours contact and at 24 hours contact for both zeolite N and zeolite A.

### Example 36

### Comparative Uptake of Alkaline Earth Ions in the Presence of Active Antimicrobial Ion-Exchanged Zeolites

Silver-exchanged zeolite N and zeolite A for comparison are prepared by the following procedure. 20 g of zeolite is added to a 5 L beaker containing 1.5 L of water. 33.97 g of silver nitrate is dissolved in 0.5 L of water and then added to the beaker containing the zeolite slurry. After 2 hours stirring at ambient temperature, the solution is decanted and the zeolite powder dried at 110° C.

Silver-exchanged zeolites are then contacted with an aqueous solution containing 100 mg/L calcium ions and 20 mg/L magnesium ions to determine the degree of alkaline earth ion uptake by the exchanged zeolite. The test solution is made by adding appropriate amounts of calcium chloride and magnesium sulphate salts to deionized water. 0.2 g of zeolite is then added to 200 mL of the alkaline earth test solution for a period of 1 hour at ambient temperature. Atomic Adsorption Spectroscopy (AAS) is employed to measure the concentration of calcium and magnesium ions in solution both before and after contact with the silver zeolite material. The amount of calcium or magnesium ion exchanged in terms of millimoles is then calculated from the measured concentrations. The uptake of Ca and Mg ions (as meq/100 g of zeolite) for zeolite N and zeolite A is 47 g/kg and 348 g/kg, respectively.

These CEC values show that Ca and Mg ions are readily exchanged by zeolite A—as previously described and known in prior art. The low uptake for Ca and Mg ions demonstrated by zeolite N suggests that silver ion is released to the test solution in a more controlled manner compared with zeolite A. Extensive re-use applications of Ag-exchanged zeolite A may result in loss of antimicrobial activity more rapidly than Ag-exchanged zeolite N.

### Example 37

### Ammonia Gas Adsorption Using Zeolite N

Silver-exchanged zeolite N is prepared by the following procedure: 20 g of zeolite is added to a 5 L beaker containing 1.5 L of water. 33.97 g of silver nitrate is dissolved in 0.5 L of water and then added to the beaker containing the zeolite slurry. After 2 hours of stirring at ambient temperature the solution is decanted and the zeolite dried at 110° C.

Zinc-exchanged zeolite N is prepared as follows: 500 mL of 0.454M zinc nitrate solution is mixed with 50 g of zeolite N, stirred and heated at 50° C. for a period of 5 hours. After decanting the solution, a second exchange is performed with fresh zinc nitrate solution. Finally, the zinc-exchanged zeolite N is washed and dried at 110° C.

Approximately 0.25 g samples of silver-exchanged and zinc-exchanged zeolite N (zeolite Ag—N and zeolite Zn—N) are placed in a temperature-controlled reactor vessel and subjected to air flows of composition listed in Table 13 using mass-flow controllers. The space velocity maintained for all experiments is 50,000 hr⁻¹. The reactor vessel is subjected to a controlled heating and cooling sequence to measure the adsorption of ammonia gas over a fixed period of two hours at two operating temperatures −80° C. and 120° C. The ammonia gas content on the adsorbers is measured by distillative removal of ammonia species. Data for ammonia gas adsorption at 80° C. and 120° C. are provided in Table 13.

### Example 38

### Absorption of Anions from Wastewater using Zeolite N

Granules of test material(s) are loaded into glass columns (φ˜52 mm; packed bed height ˜750 mm) with inlet and outlet openings suited to flow of test solutions and analysis of samples as noted in Example 25. Wastewater at pH 8.0 produced by an anaerobic digester side stream circuit in a sewage treatment plant is introduced into the columns after a sand filtration step to remove suspended solids. Solutions are pumped at a constant flow rate of 2 bed volumes per hour for each test material. The digester side stream wastewater shows typical concentrations for Ca²⁺ and Mg²⁺ (43 mg/L and 13 mg/L, respectively), Na⁺ and K⁺ (320 mg/L and 230 mg/L, respectively) as well as high levels of ammonium, alkalinity, BOD, COD and total dissolved solids (1,528 mg/L, 4,500 mg/L, 94 mg/L, 1,300 mg/L and 2,100 mg/L, respectively). The inlet phosphate ion concentration is 265 mg/L.

Data for this example are listed in Table 14 for treatment of the wastewater at 5 bed volumes and at 50 bed volumes of flow, respectively. Table 14 shows that total phosphorus is reduced from 230 mg/L to 120 mg/L and 190 mg/L, respectively at 5 bed volumes and 50 bed volumes of treated wastewater. Under these conditions, which include many competing ions, reduction of iron, manganese and zinc also occurs as shown in Table 14.

### Example 39

### Comparative Oil Absorption

Samples of zeolite N (Examples 1,4, 7-11, 13 and 20) are subjected to a standard linseed oil absorption test and compared with the following commercially available materials: (a) Alumina Hydrate (AS303 supplied by Commercial Minerals Ltd.), (b) Activebond 23 Bentonite (supplied by Commercial Minerals Ltd); (c) Zeolite 4A (supplied by PQ Corporation), (d) Trubond MW Bentonite (supplied by Commercial Minerals Ltd.), (e) Kingaroy kaolin (Kingwhite 65, Unimin Aust.,Pty Ltd), (f) attapulgite (Clay Minerals Society Source Clays: PF1-1 from Gadsen County FL). The results of these standard oil absorption tests on zeolite N samples from Examples 1, 4, 7 to 11, 13 and 20 as well as commercially available materials are shown in Table 15.

Table 15 shows that zeolite N has high oil absorption capacity and significantly higher values than bentonites and zeolite 4A. Oil absorption capacity for zeolite N is better than that for zeolite X (for which property this material is used in detergents) or zeolite A and, is similar to, or better than that for attapulgite, bentonite, kaolin and alumina hydrate.

TABLE 1
Comparison of reaction conditions for selected zeolites produced by prior art

| | Parameter | | | | |
|---|---|---|---|---|---|
| Batch | | | | | Barrer & Munday |
| Composition | Barrer et al. (1953) | | Barrer and Marcilly (1970) | | (1971) |
| Material Type | analcime | gel | Na-X | kaolin | kaolin |
| SiO₂/Al₂O₃ | 4 | 4 | 2.5 | 2 | 2 |
| K₂O/Al₂O₃ | 0 | 0.78 | 0 | 1 | 19.9 |
| Na₂O/Al₂O₃ | 1 | 0 | 1 | 0 | 0 |
| H₂O/Al₂O₃ | 88 | >68 | 284 | 103 | 378 |
| KCl/Al₂O₃ | 12 | Not defined | 67 | 24.4 | 0 |
| NaCl/Al₂O₃ | 0 | 0 | 0 | 0 | 0 |
| Temperature (° C.) | 450 | 450 | 260 | >200 | 80 |
| Time (days) | 2 | 1 | 4 | 4 | 12 |
| Mass of Materials | <15 g | <10 g | <15 g | <10 g | 27 g |
| Batch Method(s) | Static; autoclave | Static; autoclave | Static; autoclave | Static; autoclave | Static; autoclave |
| Product | Leucite + Zeolite N | Kalsilite + Zeolite N | Zeolite F | kaliophilite | Zeolite F |

TABLE 2
Comparison of reaction conditions for zeolite N produced by this work
and by prior art; Includes other phases near zeolite N stability field

| | Parameter | | | | | | |
|---|---|---|---|---|---|---|---|
| | | This | This | This | This | | |
| | Christensen | Work | Work | Work | Work | This | This |
| | & Fjelvag | Example | Example | Example | Example | Work | Work |
| Batch Composition | (1997) | 1 | 4 | 5 | 6 | Example 7 | Example 9 |
| Material Type | Na-A | kaolin | kaolin | kaolin | kaolin | kaolin | montmorillo- |
| | | | | | | | nite |
| SiO₂/Al₂O₃ | 2 | 2 | 2 | 2 | 2 | 2.2 | 4 |
| K₂O/Al₂O₃ | 0 | 2.3 | 2.8 | 2.5 | 1.7 | 2.5 | 5.6 |
| Na₂O/Al₂O₃ | 1 | 0 | 0 | 0 | 1.0 | 0 | 0 |
| H₂O/Al₂O₃ | 205 | 50 | 46 | 60 | 51 | 51 | 54 |
| KCl/Al₂O₃ | 12.3 | 3.5 | 0 | 9.5 | 2.0 | 3.5 | 6.3 |
| NaCl/Al₂O₃ | 0 | 0 | 2.2 | 2.8 | 0.8 | 0 | 0 |
| Cl/SiO₂ | 6.2 | 1.7 | 1.1 | 6.1 | 1.4 | 4.0 | 1.6 |
| Cation ratio* | 0.9 | 1.0 | 0.7 | 0.8 | 0.7 | 1.0 | 1.0 |
| Excess alkalinity* | 6.7 | 3.5 | 3.5 | 8.1 | 3.6 | 3.4 | 4.1 |
| Temperature (° C.) | 300 | 95 | 95 | 95 | 95 | 95 | 95 |
| Time (days) | 7 | 0.25 | 0.25 | 0.25 | 0.25 | 0.25 | 0.4 |
| Mass of Materials | 135 g | 475 kg | 345 kg | 5.2 kg | 4.0 kg | 4.3 kg | 4.3 kg |
| Batch Method(s) | Static, | Stirred; | Stirred; | Stirred, | Stirred, | Stirred; | Stirred; |
| | autoclave | ambient P | ambient P | ambient P | ambient P | ambient P | ambient P |
| Product | Zeolite N | Zeolite N | Zeolite N | Zeolite N | Zeolite N | Zeolite N | Zeolite N |
| Si/Al | 1.0 | 1.05 | 1.07 | 1.04 | 1.07 | 1.11 | 2.4 |

Parameter

| | This | This | This | This | This | This |
|---|---|---|---|---|---|---|
| | Work | Work | Work | Work | Work | Work |
| | Example | Example | Example | Example | Example | Example |
| Batch Composition | 10 | 11 | 12 | 15 | 16 | 18 |
| Material Type | kaolin | kaolin | kaolin | Na-A | Na-A | kaolin |
| SiO₂/Al₂O₃ | 2 | 2 | 2 | 2 | 2 | 2 |
| K₂O/Al₂O₃ | 11.5 | 4.6 | 11.5 | 0 | 0 | 2.5 |
| Na₂O/Al₂O₃ | 0 | 0 | 0 | 1 | 1 | 0 |
| H₂O/Al₂O₃ | 51 | 51 | 126 | 205 | 58 | 51 |
| KCl/Al₂O₃ | 0 | 0 | 12.1 | 12.3 | 12.3 | 0.5 |
| NaCl/Al₂O₃ | 0 | 0 | 0 | 0 | 0 | 0.5 |
| Cl/SiO₂ | 0 | 2.7 | 6.1 | 6.2 | 6.2 | 0.5 |
| Cation ratio* | 1.0 | 1.0 | 1.0 | 0.9 | 0.9 | 0.9 |
| Excess alkalinity* | 11.0 | 4.1 | 17.1 | 6.7 | 6.7 | 2.3 |
| Temperature (° C.) | 90 | 95 | 80 | 95 | 95 | 95 |
| Time (days) | 0.5 | 0.25 | 0.5 | 0.25 | 0.25 | 0.25 |
| Mass of Materials | 2.9 kg | 4.4 kg | 6.6 kg | 3.5 kg | 4.6 kg | 3.7 kg |
| Batch Method(s) | Stirred; | Stirred; | Stirred; | Stirred; | Stirred; | Stirred; |
| | ambient P | ambient P | ambient P | ambient P | ambient P | ambient P |
| Product | Zeolite N | Zeolite N | Zeolite N | Zeolite A | Zeolite A | KAD |
| Si/Al | 1.03 | 1.04 | 1.04 | un | un | un |

*Cation Ratio is calculated by the equation: f = K/(K + Na). Excess Alkalinity calculated by the equation: m = (K + Na − Al)/Si
un = unavailable.

TABLE 3
Compositional forms of Zeolite N disclosed in the examples

| | M** | N** | Si:Al | X** | Y** |
|---|---|---|---|---|---|
| Example 1 | K | — | 1.0 | Cl | — |
| Example 4 | K | Na | 1.1 | Cl | — |
| Example 6 | K | Na | 1.1 | Cl | (OH)* |
| Example 8 | K | — | 1.2 | Cl | — |
| Example 9 | K | (Fe, Mg)* | 2.4 | Cl | (OH)* |
| Example 10 | K | — | 1.0 | — | OH |
| Example 11 | K | NH₄ | 1.0 | Cl | — |
| Example 19 | K | Na | 1.0 | Cl | (NO)* |
| Example 20 | NH₄ | K | 1.0 | Cl | (NO)* |
| Example 33 | K | Cu | 1.0 | Cl | — |
| Example 33 | K | Zn | 1.0 | Cl | — |
| Example 33 | K | Ni | 1.0 | Cl | — |
| Example 33 | K | Co | 1.0 | Cl | — |
| Example 33 | K | Cd | 1.0 | Cl | — |
| Example 35 | K | NH₄, Zn, Ag | 1.0 | Cl | (NO)* |
| Example 37 | Na | Ag | 1.0 | Cl | (NO)* |
| Example 37 | K | Zn | 1.0 | Cl | (NO)* |

*Inferred by stoichiometry
**refer to general formula for zeolite N

TABLE 4
Comparison of hkl, 2θ (obs) and intensity for X-ray Diffraction patterns from selected examples

| | | | Zeolite N | | Zeolite N | | Zeolite N | | 87-2476 | |
|---|---|---|---|---|---|---|---|---|---|---|
| Indices | | | Example 8 | | Example 10 | | Example 11 | | Christensen & Fjellvag | |
| H | K | L | 2Theta (Obs) | Iₕₖₗ | 2Theta (Obs) | Iₕₖₗ | 2Theta (Obs) | Iₕₖₗ | 2Theta (Obs) | Iₕₖₗ |
| 1 | 0 | 1 | 11.20 | 6 | | | | | 11.19 | 24 |
| 0 | 1 | 1 | | | | | 11.24 | 5 | 11.19 | 24 |
| 1 | 1 | 0 | 12.64 | 44 | 12.59 | 48 | 12.70 | 49 | 12.64 | 87 |
| 0 | 0 | 2 | 13.54 | 11 | 13.54 | 11 | 13.58 | 13 | 13.52 | 24 |
| 0 | 2 | 0 | | | | | 17.92 | 5 | | |
| 1 | 1 | 2 | 18.54 | 5 | 18.46 | 10 | 18.53 | 9 | 18.55 | 8 |
| 2 | 1 | 1 | | | | | 21.12 | 11 | 21.17 | 10 |
| 1 | 2 | 1 | 21.21 | 7 | 21.23 | 12 | 21.22 | 13 | 21.17 | 10 |
| 1 | 0 | 3 | 22.24 | 4 | | | 22.24 | 11 | 22.25 | 3 |
| 0 | 2 | 2 | 22.64 | 3 | | | 22.64 | 9 | | |
| 2 | 2 | 0 | 25.47 | 36 | 25.41 | 19 | 25.48 | 33 | 25.44 | 44 |
| 0 | 0 | 4 | 27.23 | 24 | 27.16 | 20 | 27.30 | 19 | 27.23 | 26 |
| 3 | 0 | 1 | | | | | 27.70 | 16 | 27.90 | 3 |
| 0 | 3 | 1 | 27.92 | 7 | 28.04 | 17 | | | 27.90 | 3 |
| 3 | 1 | 0 | | | 28.44 | 40 | 28.38 | 35 | 28.52 | 36 |
| 1 | 3 | 0 | 28.58 | 42 | | | | | 28.52 | 36 |
| 2 | 1 | 3 | | | | | 28.65 | 68 | 28.70 | 27 |
| 2 | 2 | 2 | 28.95 | 97 | 28.92 | 100 | 28.98 | 83 | 28.92 | 100 |
| 1 | 1 | 4 | 30.13 | 82 | 30.00 | 77 | 30.20 | 100 | 30.12 | 77 |
| 1 | 3 | 2 | 31.72 | 100 | 31.68 | 78 | 31.75 | 71 | 31.65 | 98 |
| 2 | 0 | 4 | | | 32.63 | 16 | | | 32.80 | 19 |
| 0 | 2 | 4 | 32.85 | 18 | 32.90 | 16 | | | 32.80 | 19 |
| 2 | 3 | 1 | 33.39 | 27 | 33.37 | 21 | 33.38 | 27 | 33.34 | 35 |
| 3 | 0 | 3 | | | | | 33.84 | 14 | | |
| 0 | 3 | 3 | 34.11 | 6 | 34.18 | 18 | | | | |
| 1 | 0 | 5 | 35.45 | 9 | | | | | 35.44 | 5 |
| 0 | 1 | 5 | | | | | 35.53 | 17 | 35.44 | 5 |
| 4 | 0 | 0 | | | 36.13 | 12 | 36.07 | 15 | | |
| 0 | 4 | 0 | | | 36.54 | 11 | | | | |
| 2 | 2 | 4 | 37.68 | 7 | | | 37.62 | 17 | 37.61 | 3 |
| 4 | 1 | 1 | 38.08 | 7 | 38.02 | 12 | 37.89 | 15 | 38.06 | 3 |
| 3 | 3 | 0 | | | 38.56 | 18 | 38.50 | 20 | 38.57 | 1 |
| 3 | 2 | 3 | 38.67 | 9 | | | | | 38.72 | 4 |
| 0 | 4 | 2 | 38.95 | 7 | 39.10 | 11 | | | 38.92 | 3 |
| 3 | 1 | 4 | | | | | 39.71 | 24 | 39.84 | 14 |
| 1 | 3 | 4 | 39.90 | 21 | 39.85 | 23 | | | 39.84 | 14 |
| 1 | 2 | 5 | | | | | 39.98 | 26 | 39.99 | 11 |
| 4 | 2 | 0 | | | | | 40.52 | 14 | | |
| 2 | 4 | 0 | 40.86 | 6 | 40.79 | 13 | | | | |
| 3 | 3 | 2 | 41.12 | 10 | 41.06 | 14 | 40.99 | 15 | 41.05 | 5 |
| 0 | 0 | 6 | 41.32 | 9 | 41.33 | 13 | 41.33 | 12 | 41.35 | 3 |
| 4 | 1 | 3 | 42.95 | 15 | 42.95 | 18 | | | 42.95 | 12 |
| 4 | 2 | 2 | | | | | 42.95 | 16 | | |
| 2 | 4 | 2 | 43.15 | 14 | 43.22 | 17 | 43.22 | 18 | | |
| 1 | 1 | 6 | 43.49 | 7 | 43.42 | 15 | | | 43.11 | 3 |
| 3 | 0 | 5 | | | 44.03 | 12 | | | 44.11 | 2 |
| 0 | 3 | 5 | 44.16 | 5 | | | 44.16 | 15 | 44.11 | 2 |
| 2 | 0 | 6 | | | | | 45.38 | 13 | | |
| 4 | 0 | 4 | | | 45.92 | 12 | 45.85 | 16 | 45.98 | 6 |
| 0 | 4 | 4 | 46.01 | 11 | | | 45.98 | 14 | 45.98 | 6 |

TABLE 5
Comparison of caustic use with and without recycling

| Reactant Masses | Without Recycle | With Recycle |
|---|---|---|
| Mass of kaolin (kg) | 675 | 675 |
| Mass of caustic (kg) | 1,350 | 821 |
| Mass of zeolite N (kg) | 783 | 783 |
| Caustic:Product ratio | 1.7 | 1.05 |

TABLE 6
Properties of zeolite N produced by examples

| | Refined Cell Dimensions | | | | | | | | | | | BET |
|---|---|---|---|---|---|---|---|---|---|---|---|---|
| | (I222 Space Group) | | | | | | | | | | | Surface |
| | a | b | c | Bulk Analysis | | | | | | | CEC | Area |
| Sample No | (A) | (A) | (A) | SiO₂ | Al₂O₃ | K₂O | Na₂O | Cl | LOI | Si:Al | (meq/100 g) | (m²/g) |
| Example 1 | 9.924(3) | 9.893(4) | 13.114(3) | 34.5 | 28.4 | 27.2 | <0.5 | 2.4 | 7.2 | 1.03 | 528 | 10.7 |
| Example 2, Run 1 | 9.920(3) | 9.866(3) | 13.092(3) | 33.4 | 26.5 | 23.2 | <0.5 | 2.5 | 11.1 | 1.07 | 499 | 9.9 |
| Example 2, Run 3 | 9.911(3) | 9.872(3) | 13.094(4) | 34.6 | 28.0 | 24.4 | <0.5 | 2.4 | 7.2 | 1.05 | 530 | 5.3 |
| Example 2. Run 5 | 9.923(3) | 9.889(4) | 13.112(3) | 33.4 | 27.0 | 23.4 | <0.5 | 2.4 | 10.4 | 1.05 | 532 | 11.4 |
| Example 2, Run 8 | 9.923(4) | 9.886(5) | 13.105(5) | 34.4 | 28.1 | 24.2 | <0.5 | 2.3 | 7.6 | 1.04 | 503 | 10.5 |
| Example 3 | 9.942(2) | 9.876(3) | 13.102(4) | 36.0 | 27.7 | 26.7 | <0.5 | 2.6 | 6.89 | 1.10 | 518 | 14.8 |
| Example 4 | 9.920(2) | 9.863(2) | 13.097(3) | 36.0 | 28.6 | 24.6 | 1.4 | 2.2 | 7.26 | 1.07 | 504 | 13.6 |
| Example 5* | 9.923(2) | 9.852(2) | 13.075(3) | 33.9 | 27.8 | 22.9 | 1.4 | 2.3 | 10.9 | 1.04 | 493 | 10.3 |
| Example 6 | 9.941(2) | 9.866(2) | 13.079(3) | 35.3 | 27.9 | 22.7 | 1.5 | 1.7 | 9.9 | 1.07 | 471 | 13.4 |
| Example 7 | 9.899(3) | 9.833(3) | 13 059(4) | 35.8 | 27.6 | 22.8 | <0.5 | 2.0 | 10.7 | 1.10 | 493 | 12.6 |
| Example 8 | 9.910(2) | 9.872(2) | 13.080(2) | 38.2 | 26.3 | 25.8 | <0.5 | 3.0 | 6.7 | 1.23 | 490 | 10.1 |
| Example 9 | 9.926(2) | 10.012(3) | 13.196(4) | 48.2 | 17.3 | 16.6 | <0.5 | 1.6 | 8.3 | 2.36 | 309 | 99.9 |
| Example 10* | 9.929(3) | 9.852(3) | 13.104(4) | 34.8 | 28.6 | 23.4 | 0.9 | <0.1 | 7.4 | 1.03 | 211 | 55.0 |
| Example 11* | 9.946(2) | 9.870(2) | 13.084(3) | 36.3 | 29.7 | 19.3 | 0.6 | 1.5 | 11.0 | 1.04 | 397 | 21.9 |
| Example 12 | 9.918(2) | 9.870(3) | 13.093(4) | 33.0 | 27.0 | 24.4 | <0.5 | 2.5 | 11.5 | 1.04 | 474 | 12.1 |
| Example 13* | 9.933(2) | 9.869(2) | 13.092(4) | 35.7 | 28.6 | 20.8 | 1.3 | 1.3 | 10.6 | 1.08 | 458 | 17.2 |
| Example 19 | 9.932(2) | 9.863(2) | 13.087(3) | 35.9 | 29 1 | 17.4 | 4.5 | 1.8 | 10.3 | 1.05 | 510 | 15.5 |
| Example 20 | 9.953(2) | 9.880(2) | 13.214(3) | 37.6 | 31.9 | 2.0 | 0.1 | 2.3 | 23.4 | 1.00 | 519 | 14.7 |

⁺CEC values determined for 1M NH₄Cl equilibrium exchange as described under “Standard Procedures”.
*CEC values are “dry weight” determinations.

TABLE 7
Comparison of aluminosilicate properties

| | | | | | Zeolite N |
|---|---|---|---|---|---|
| Property | Kaolin | Montmorillonite | Clinoptilolite | Zeolite 4A | (Example 1) |
| Si:Al | 1.09 | 3.64 | 4.5 | 1.0 | 1.03 |
| CEC⁺ (meq/100 g) | 19 | 64 | 110 | 472 | 528 |
| CEC* (meq/L) | un | un | 1,331 | 2,832 | 4,224 |
| Surface area (m²/g) | 15.2 | 78 | 11.5 | 2.3 | 10.7 |

⁺CEC values determined for 1M NH₄Cl equilibrium exchange as described under “Standard Procedures”.
un = unavailable.
*value determined on granule density.

TABLE 8
Solution compositions for Example 23

| | Ammonium ion | Calcium ion | Magnesium ion |
|---|---|---|---|
| | concentration | concentration | concentration |
| | (mg/L) | (mg/L) | (mg/L) |
| Solution 1 | 30 | 50 | 20 |
| Solution 2 | 200 | 50 | 20 |
| Solution 3 | 1000 | 50 | 20 |
| Solution 4 | 30 | 120 | 20 |
| Solution 5 | 200 | 120 | 20 |
| Solution 6 | 1000 | 120 | 20 |

TABLE 9
Loading data for calcium, magnesium and ammonium
ions on zeolites described in Example 23

| | Solution 1 | Solution 2 | Solution 3 | Solution 4 | Solution 5 | Solution 6 |
|---|---|---|---|---|---|---|
| Ca²⁺ Loading (meq/100 g) | | | | | | |
| Zeolite N (Example 1) | 10 | 25 | 18 | 16 | 32 | 28 |
| Zeolite N (Example 19) | 23 | 20 | 9 | 25 | 29 | 16 |
| Zeolite 4A | 229 | 236 | 206 | 423 | 379 | 297 |
| Clinoptilolite | −17 | −4 | −15 | −9 | −1 | −6 |
| Mg²⁺ Loading (meq/100 g) | | | | | | |
| Zeolite N (Example 1) | 4 | 0 | 0 | 3 | 1 | 0 |
| Zeolite N (Example 19) | 5 | 0 | 0 | 5 | 0 | 0 |
| Zeolite 4A | 37 | 22 | 7 | 10 | 4 | −1 |
| Clinoptilolite | 2 | 0 | −4 | 4 | 1 | −6 |
| NH₄⁺ Loading (meq/100 g) | | | | | | |
| Zeolite N (Example 1) | 104 | 347 | 444 | 104 | 331 | 475 |
| Zeolite N (Example 19) | 118 | 406 | 451 | 119 | 326 | 434 |
| Zeolite 4A | 68 | 172 | 261 | 34 | 112 | 192 |
| Clinoptilolite | 8 | 76 | 71 | 8 | 54 | 115 |

TABLE 10
Ammonium selectivity of zeolites in
alkali-rich solution (Example 30)

| | Zeolite N | Zeolite N | Zeolite | Clino- |
|---|---|---|---|---|
| | (Example 1) | (Example 19) | 4A | ptilolite |
| NH₄ (meq/100 g) | 128 | 155 | 74 | 5 |
| Ca (meq/100 g) | 5 | 10 | 24 | −15 |
| Na (meq/100 g) | 15 | −117 | −209 | 9 |
| K (meq/100 g) | −160 | −53 | 98 | 12 |
| Excess Ions | −12 | −5 | −13 | 11 |
| % Selectivity (NH₄) | 87 | 94 | 38 | 0 |

TABLE 11
Metal ion selectivity of zeolites in presence of Ca²⁺ (Example 33)

| | Zeolite N | Zeolite N | | |
|---|---|---|---|---|
| | (Example 1) | (Example 19) | Zeolite 4A | Clinoptilolite |
| Copper/Calcium | | | | |
| Loading Cu (meq/100 g) | 115 | 127 | 145 | 4 |
| Loading Ca (meq/100 g) | 22 | 35 | 290 | 8 |
| Total Adsorbed Ions | 137 | 162 | 435 | 12 |
| Total Released Ions | −133 | −167 | −493 | −9 |
| Excess Ions | 4 | −5 | −58 | 3 |
| % Selectivity (Cu) | 84 | 79 | 33 | 32 |
| Zinc/Calcium | | | | |
| Loading Zn (meq/100 g) | 73 | 82 | 121 | 3 |
| Loading Ca (meq/100 g) | 18 | 22 | 269 | 13 |
| Total Adsorbed Ions | 91 | 104 | 390 | 16 |
| Total Released Ions | −107 | −142 | −457 | −30 |
| Excess Ions | −16 | −38 | −67 | −14 |
| % Selectivity (Zn) | 80 | 79 | 31 | 18 |
| Cadmium/Calcium | | | | |
| Loading Cd (meq/100 g) | 45 | 63 | 81 | 1 |
| Loading Ca (meq/100 g) | 10 | 13 | 385 | 0 |
| Adsorbed Ions | 55 | 76 | 466 | 1 |
| Released Ions | −76 | −104 | −496 | −6 |
| Excess Ions | −21 | −28 | −30 | −5 |
| % Selectivity (Cd) | 81 | 83 | 17 | 100 |
| Nickel/Calcium | | | | |
| Loading Ni (meq/100 g) | 35 | 62 | 8 | 4 |
| Loading Ca (meq/100 g) | 28 | 35 | 456 | 0 |
| Adsorbed Ions | 63 | 97 | 464 | 4 |
| Released Ions | −74 | −113 | −487 | −6 |
| Excess Ions | −11 | −16 | −23 | −2 |
| % Selectivity (Ni) | 56 | 64 | 2 | 100 |
| Cobalt/Calcium | | | | |
| Loading Co (meq/100 g) | 32 | 54 | 17 | 7 |
| Loading Ca (meq/100 g) | 26 | 40 | 440 | 6 |
| Adsorbed Ions | 58 | 90 | 457 | 13 |
| Released Ions | −77 | −134 | −494 | −24 |
| Excess Ions | −19 | −44 | −37 | −11 |
| % Selectivity (Co) | 55 | 57 | 4 | 52 |
| Lead/Calcium | | | | |
| Loading Pb (meq/100 g) | 48 | 49 | 48 | 12 |
| Loading Ca (meq/100 g) | 100 | 120 | 497 | 83 |
| Adsorbed Ions | 148 | 160 | 545 | 95 |
| Released Ions | −92 | −114 | −499 | −12 |
| Excess Ions | 56 | 46 | 46 | 83 |
| % Selectivity (Pb) | 33 | 29 | 9 | 12 |

TABLE 12
Comparison of Antibactericidal Activity
for Zeolite N and Zeolite A

| | Four hour Exposure | | Twenty-four hour Exposure | |
|---|---|---|---|---|
| Bacterial Strain | Zeolite N | Zeolite A | Zeolite N | Zeolite A |
| E. coli | 100 | 100 | 100 | 100 |
| P. aeruginosa | 100 | 100 | 100 | 100 |
| S. aureus | 99.98 | 100 | 99.996 | 100 |

TABLE 13
Gas adsorption behaviour for zeolite N

| | | Ammonia |
|---|---|---|
| | Adsorption | Loading |
| Material | Temperature (° C.) | (g/kg) |
| Ag-Zeolite N¹ | 80 | 66.9 |
| Zn-Zeolite N² | 80 | 30.3 |
| Zn-Zeolite N³ | 120 | 37.8 |

Notes for Table 14:
¹Gas composition; 1000 ppm NH₃, 15% CO₂, 10% N₂, 30% H₂O & 44.9% H₂
²Gas composition: 1000 ppm NH₃, 2000 ppm NO, 9.9% CO₂, 8% H₂O & 71.4% N₂
³Gas composition: 1000 ppm NH₃, 10% H₂O & 89.9% N₂

TABLE 14
Reduction of total phosphorus and other ions from wastewater

| | | Treated Side | Treated Side |
|---|---|---|---|
| | Raw Side | stream | stream |
| Property | stream | (5 BV) | (50 BV) |
| pH | 8.0 | 9.8 | 8.9 |
| Suspended solids (mg/L) | 360 | 72 | 88 |
| Total Phosphorus (mg/L) | 230 | 120 | 190 |
| Fe (mg/L) | 4.1 | 0.6 | 0.72 |
| Mn (mg/L) | 0.16 | 0.03 | 0.03 |
| Zn (mg/L) | 0.44 | 0.07 | 0.07 |

TABLE 15
Comparative oil absorption capacities
for various absorbents and zeolite N

| | Oil Absorption |
|---|---|
| Material | Capacity (g/100 g) |
| Alumina | 20 |
| Bentonite | 23 |
| Zeolite 4A | 35 |
| Kaolin | 42 |
| Attapulgite | 86 |
| Zeolite N (Example 1) | 81 |
| Zeolite N (Example 4) | 90 |
| Zeolite N (Example 7) | 103 |
| Zeolite N (Example 8) | 89 |
| Zeolite N (Example 9) | 68 |
| Zeolite N (Example 10) | 128 |
| Zeolite N (Example 11) | 140 |
| Zeolite N (Example 13) | 139 |
| Zeolite N (Example 20) | 125 |

### BIBLIOGRAPHY

Acara, N. A., U.S. Pat. No. 3,414,602, Dec. 3, 1968.
Baerlocher, Ch. and R. M. Barrer, Z. Kristallogr., 140, 10-26, 1974.
Baerlocher, Ch., and W. M. Meier, Z. Kristallogr., 135, 339-354, 1972.
Barrer, R. M. and J. W. Baynham, J. Chem. Soc., 2882-2891, 1956.
Barrer, R. M., K. Bromley and P. J. Denny, U.S. Pat. No. 3,306,922, Feb. 28, 1967.
Barrer, R. M., L. Hinds and E. A. White, J. Chem Soc., 1466-1475,1953.
Barrer, R. M. and C. Marcilly, J. Chem. Soc. (A), 2735-2745, 1970.
Barrer, R. M. and B. M. Munday, J. Chem. Soc. (A), 2914-2920, 1971.
Breck, D. W. “Zeolite Molecular Sieves: structure, chemistry and use”, John Wiley and Sons, New York, 771 pp, 1974.
Breck, D. W. U.S. Pat. No. 3,723,308, Mar. 27, 1973.
Christensen, A. Norlund and H. Fjellvag, Acta Chemica Scandinavica, 51, 969-973, 1997.
Christensen, A. Norlund and H. Fjellvag, Acta Chemica Scandinavica, 53, 85-89, 1999.
Jaynes, W. F. and J. M. Bigham, Clays and Clay Minerals, 34, 93-98, 1986.
Komarowski, S. and Q. Yu, Environmental Tech., 18, 1085-1097, 1997.
Mackinnon, I. D. R., D. Page and B. Singh, U.S. Pat. No. 6,218,329B1, Mar. 13, 2001.
Mackinnon, I. D. R., D. Page and B. Singh, U.S. Pat. No. 6,218,329B2, Apr. 17, 2001.
Sherman, J. D. In Molecular Sieves II (J. R. Katzer, ed.) ACS Symposium Series, 30-42, American Chemical Society, Washington D.C., 1977.
Sherman, J. D. and R. J. Ross, U.S. Pat. No. 4,344,851, Aug. 17, 1982.
Szostak, R., Molecular Sieves. Principles of Synthesis and Identification. Blackie Academic and Professional, 2^{nd} edition, 359 pp. 1998.
Thompson, J. G., I. D. R. Mackinnon, S. Koun and N. Gabbitas, U.S. Pat. No. 5,858,081, Jan. 12, 1999.
Van Olphen, H., and J. J. Fripiat (eds) Data Handbook for Clay Materials and other Non-metallic Minerals, Pergamon Press, 346 pp. 1979.
Weitkamp, J. and L. Puppe (Eds.), Catalysis and Zeolites: Fundamentals and Applications, Springer-Verlag, Berlin, 1999.

1-63. (canceled)

64. A process for making aluminosilicates of zeolite N structure comprising the steps of:
(i) combining a water soluble monovalent cation, a solution of hydroxyl anions and an aluminosilicate to form a resultant mixture having a pH greater than 10 and a H₂O/Al₂O₃ molar ratio in the range 30 to 220;
(ii) heating and stirring the resultant mixture to a temperature of between 50° and the boiling point of the mixture for a time between 1 minute and 100 hours until a crystalline product of zeolite N structure is formed as determined by X-ray diffraction or other suitable characteristic; and
(iii) separating the zeolite N product as a solid from the mixture.

65. A process as claimed in claim 64 wherein the water soluble monovalent cation in step (i) is an alkali metal or an ammonium ion or mixtures of these ions.

66. A process as claimed in claim 65 wherein the alkali metal comprises a potassium ion.

67. A process as claimed in claim 65 wherein the alkali metal comprises both a potassium and sodium ion.

68. A process as claimed in claim 65 wherein the monovalent cation comprises both potassium and ammonium ions.

69. A process as claimed in claim 64 wherein the resultant mixture of step (i) also contains a halide.

70. A process as claimed in claim 69 wherein the halide is chloride.

71. A process as claimed in claim 64 wherein the pH of the solution of hydroxyl ions is greater than 13.

72. A process as claimed in claim 64 wherein in step (ii) the resultant mixture is heated to a temperature of in the range 80° C. to 95° C.

73. A process as claimed in claim 64 wherein the aluminosilicate has a Si:Al ratio in the range 1.0 to 5.0.

74. A process as claimed in claim 73 wherein the aluminosilicate has a Si:Al ratio in the range 1.0 to 3.0

75. A process as claimed in claim 73 wherein the aluminosilicate is a clay.

76. A process as claimed in claim 75 wherein the clay is kaolin, meta-kaolin or montmorillonite or mixtures thereof.

77. A process as claimed in claim 64 wherein in step (ii) said heating is carried out for a time in the range 2 to 24 hours.

78. A process as claimed in claim 64 wherein the molar ratio of H₂O/Al₂O₃ in the mixture of step (i) is in the range 45 to 65.

79. A process as claimed in claim 64 wherein in step (i) a quantity of solid zeolite N is added to the mixture.

80. A process as claimed in claim 64 wherein caustic liquor remaining in the mixture after step (iii) is re-used as at least part of a solution of anions and cations in step (i) for subsequent production of additional zeolite N product.

81. A process as claimed in claim 66 wherein the amount of potassium utilized is governed by a molar ratio of K₂O/Al₂O₃ in the range of 0.3 to 15.

82. A process as claimed in claim 66 wherein the amount of potassium utilized is governed by a molar ratio of K₂O/Al₂O₃ in the range of 0.0 to 15.

83. A process as claimed in claim 70 wherein the amount of chloride utilized is governed by a molar ratio of Kcl/Al₂O₃ in the range of 0.0 to 15.

84. A process as claimed in claim 67 wherein the alkali metal is sodium and the amount of sodium utilized is governed by a molar ratio of Na₂O/Al₂O₃ in the range of 0.0 to 2.5.

85. A process as claimed in claim 65 wherein the alkali metal is sodium and the amount of sodium utilized is governed by a molar ratio of NaCl/Al₂O₃ in the range of 0.0 to 2.8.

86. A process as claimed in claim 70 wherein the amount of chloride utilized is governed by a molar ratio of NaCl/Al₂O₃ in the range of 0.0 to 2.8.

87. A process as claimed in claim 80 wherein the amount of chloride utilized is governed by a molar ratio of Cl/Al₂O₃ in the range of 0.0 to 6.5.

88. A process as claimed in claim 67 wherein the amount of sodium and potassium utilized is governed by a ratio of K/(K+Na) in the range 0.5 to 1.0

89. A process as claimed in claim 67 wherein the amount of sodium and potassium utilized is governed by a ratio of (K+Na−Al)/Si in the range 2.0 to 18.0.

90. Zeolite N produced by the process of claim 64.

91. Zeolite N produced by the process of claim 64 having a composition according to the formula
(M1₋ₐ₁Pₐ)₁₂(Al_{b}Si_{c})₁₀O₄₀(X_{1-d}Y_{d})_{z} nH₂O where
M=alkali metal or ammonium
P=alkali metal, ammonium or metal cation (s) exchanged in Lieu of alkali metal or ammonium
X=halide and Y is an anion and
0≦a≦1, 1 ≦c/b≦oc, 0≦d≦1 and 1≦n≦10.
